(19) United States
(12) Patent Application Publication
(10) Pub. No.: US 2026/0361516 A1
(43) Pub. Date: Nov. 12, 2026

(54) DISTRIBUTED PROOFS OF POSSESSION FOR AUDITING PRIVATE KEYS

(71) Applicant: Coinbase, Inc., Oakland, CA (US)

(72) Inventors: Arash Afshar, Calgary (CA); Guy Pe'er, Talmey Yechiel (IL); Yehuda Lindell, Petah Tikva (IL); Samuel Ranellucci, Montreal (CA)

(21) Appl. No.: 19/205,707

(22) Filed: May 12, 2025

(51) Int. Cl. H04L 9/08; H04L 9/32

(52) U.S. Cl. CPC H04L 9/0825; H04L 9/3252

(57) ABSTRACT

Methods, systems, and devices for data management are described. A facilitator may receive a first request for a proof of possession of a blockchain address associated with a public key and a private key. The first request may include an audit message. The facilitator may transmit, to each entity of multiple entities possessing a respective private key share of the private key, a second request to perform a cryptographic operation associated with the audit message and using the respective private key share. The facilitator may receive, from at least a portion of the multiple entities, multiple outputs associated with the cryptographic operation and the multiple private key shares, where the multiple outputs may be insufficient to construct a verifiable signature for the blockchain address. The facilitator may output, in response to the first request, the multiple outputs and a respective multiple public key shares of the public key.

### FIELD OF TECHNOLOGY

The present disclosure relates generally to data management, including techniques for distributed proofs of possession for auditing private keys.

### BACKGROUND

Blockchains and related technologies may be employed to support recordation of ownership of digital assets, such as cryptocurrencies, fungible tokens, non-fungible tokens (NFTs), and the like. Generally, peer-to-peer networks support transaction validation and recordation of transfer of such digital assets on blockchains. Various types of consensus mechanisms may be implemented by the peer-to-peer networks to confirm transactions and to add blocks of transactions to the blockchain networks. Example consensus mechanisms include the proof-of-work consensus mechanism implemented by the Bitcoin network and the proof-of-stake mechanism implemented by the Ethereum network. Some nodes of a blockchain network may be associated with a digital asset exchange, which may be accessed by users to trade digital assets or trade a fiat currency for a digital asset.

### BRIEF DESCRIPTION OF THE DRAWINGS

FIG. 1 illustrates an example of a computing environment that supports distributed proofs of possession for auditing private keys in accordance with aspects of the present disclosure.

FIG. 2 shows an example of a signaling environment that supports distributed proofs of possession for auditing private keys in accordance with aspects of the present disclosure.

FIG. 3 shows an example of a process flow that supports distributed proofs of possession for auditing private keys in accordance with aspects of the present disclosure.

FIG. 4 shows a block diagram of an apparatus that supports distributed proofs of possession for auditing private keys in accordance with aspects of the present disclosure.

FIG. 5 shows a block diagram of a proof of possession manager that supports distributed proofs of possession for auditing private keys in accordance with aspects of the present disclosure.

FIG. 6 shows a diagram of a system including a device that supports distributed proofs of possession for auditing private keys in accordance with aspects of the present disclosure.

FIG. 7 shows a block diagram of an apparatus that supports distributed proofs of possession for auditing private keys in accordance with aspects of the present disclosure.

FIG. 8 shows a block diagram of a proof of possession manager that supports distributed proofs of possession for auditing private keys in accordance with aspects of the present disclosure.

FIG. 9 shows a diagram of a system including a device that supports distributed proofs of possession for auditing private keys in accordance with aspects of the present disclosure.

FIGS. 10 through 13 show flowcharts illustrating methods that support distributed proofs of possession for auditing private keys in accordance with aspects of the present disclosure.

### DETAILED DESCRIPTION

In some systems, multiple parties in a multi-party computation (MPC) scheme may collaborate to perform an MPC operation. As part of the MPC scheme, a cryptographic key may be distributed, via multiple key shares, to multiple parties. For example, a cryptographic key, which may be an example of a secret signing key or a secret decryption key, may be split into multiple parts via a key sharing operation, such as Shamir sharing, additive sharing, multiplicative sharing, or the like. In some cases, a threshold quantity or all of the multiple parties having the key shares of the cryptographic key (i.e., t out of n key shares) may, together, perform an MPC operation. In other words, the threshold quantity of key shares may be required to execute the MPC operation. As described herein, “party” may refer to a participant in a protocol or scheme, such as a signer, a verifier, a sender, a receiver, or the like, and the participant may be a computing device (e.g., logical or physical computing system) that operates autonomously or with user input. Additionally, a “key share” may refer to a part or portion of a key or secret value and may be used interchangeably with “key shard” or “key part.” Additionally, each key share may include a public key share, used for encryption, and a private key share, used for decryption and kept secret at each entity. Distributing the key as key shares across multiple parties may improve security and reduce the vulnerability of the key, as an attacker may need to attack all parties or a threshold quantity of parties holding key shares in order to use the key.

In some cases, an entity, such as an auditor, may request proof of possession of assets associated with the key for the parties. For example, for a blockchain system, a key may be associated with a blockchain address including one or more assets. The key may be used to control and access the assets. One or more entities, such as an auditor, may request a proof of possession for the blockchain address (e.g., or any other information or asset protected by the private key). Proof of possession for the blockchain address may include proof of possession of a cryptographic key associated with the blockchain address. To verify that a user, platform, or the like may hold the cryptographic keys associated with the blockchain address, the owner may send a signed audit message to the auditor. For example, in an MPC scheme, the parties may perform a cryptographic operation to generate a signature for an audit message using at least the threshold quantity of key shares. The auditor may receive the signed output, which may prove that the parties possess the blockchain address based on the control of the associated private key used to generate the valid signature.

However, performing a cryptographic operation to generate the proof of possession (e.g., the signed audit messages) may be associated with one or more security risks. For example, the key shares may be brought online, or made accessible by a network, to perform the operation, which may expose the key to attackers. Additionally, or alternatively, the proof of possession message, which may be a signed message, may be similar or identical to a transaction message. A transaction message may be used to transfer or control assets. An attacker may intercept the signed audit message, including the valid signature, and may use it to transfer or control the associated assets. For example, the attacker may change the signed audit message to a transaction message to steal funds. Additionally, or alternatively, performing a cryptographic operation to sign the audit message, such as via a threshold signing scheme, may be computationally expensive and time consuming.

The techniques described herein support each party independently generating outputs for a cryptographic operation using a respective private key share, where the outputs may be sufficient to act as proof of possession, but may be insufficient to construct a verifiable signature for a blockchain address. For example, an auditor may request proof of possession of a blockchain address. A facilitator, such as a lead party, a server, or a platform, may receive the request and may transmit, to each party that holds a key share, a request to perform a cryptographic operation associated with the audit message and using the respective private key shares. Each party may, independently, perform the cryptographic operation and generate an output. For example, the cryptographic operation may be a signing operation. Each party may sign an audit message with a signature based on the key share that it possesses, rather than generating a full signature. The facilitator may receive the outputs of the cryptographic operation (e.g., the signed audit messages) and may send the outputs and associated public key shares to the auditor. The auditor may verify that the individual outputs are a valid output for a cryptographic operation corresponding to the public key (e.g., formed with the associated public key shares).

By performing the cryptographic operation to generate a proof of possession for a blockchain address with key shares independently at each party, the key shares may not be brought online, which may reduce the exposure and vulnerability of the key shares, while increasing the security of the system. Additionally, or alternatively, by using a key share to perform the cryptographic operation, as opposed to a full key, the outputs generated at each party, such as the signed audit messages, may not be valid signatures for the corresponding public key. For example, the signed audit messages may not be intercepted and changed to transaction messages by an attacker, as the signatures may not be valid transaction signatures. Additionally, or alternatively, performing cryptographic operations independently at the parties may be less computationally expensive than performing a joint MPC operation.

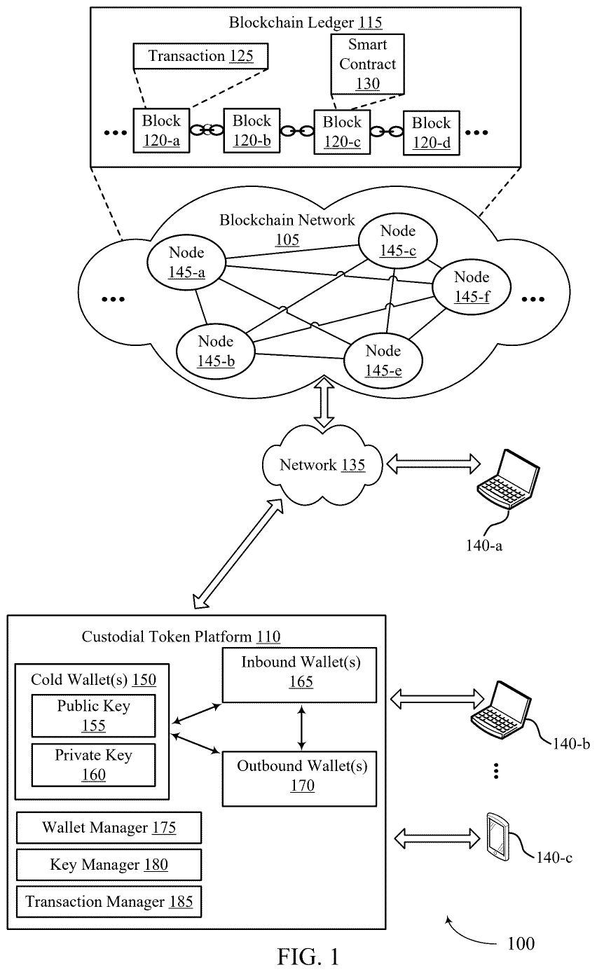

FIG. 1 illustrates an example of a computing environment 100 that supports distributed proofs of possession for auditing private keys in accordance with aspects of the present disclosure. The computing environment 100 may include a blockchain network 105 that supports a blockchain ledger 115, a custodial token platform 110, and one or more computing devices 140, which may be in communication with one another via a network 135.

The network 135 may allow the one or more computing devices 140, one or more nodes 145 of the blockchain network 105, and the custodial token platform 110 to communicate (e.g., exchange information) with one another. The network 135 may include aspects of one or more wired networks (e.g., the Internet), one or more wireless networks (e.g., cellular networks), or any combination thereof. The network 135 may include aspects of one or more public networks or private networks, as well as secured or unsecured networks, or any combination thereof. The network 135 also may include any quantity of communications links and any quantity of hubs, bridges, routers, switches, ports or other physical or logical network components.

Nodes 145 of the blockchain network 105 may generate, store, process, verify, or otherwise use data of the blockchain ledger 115. The nodes 145 of the blockchain network 105 may represent or be examples of computing systems or devices that implement or execute a blockchain application or program for peer-to-peer transaction and program execution. For example, the nodes 145 of the blockchain network 105 support recording of ownership of digital assets, such as cryptocurrencies, fungible tokens, non-fungible tokens (NFTs), and the like, and changes in ownership of the digital assets. The digital assets may be referred to as tokens, coins, crypto tokens, or the like. The nodes 145 may implement one or more types of consensus mechanisms to confirm transactions and to add blocks (e.g., blocks 120-a, 120-b, 120-c, and so forth) of transactions (or other data) to the blockchain ledger 115. Example consensus mechanisms include a proof-of-work consensus mechanism implemented by the Bitcoin network and a proof-of-stake consensus mechanism implemented by the Ethereum network.

When a device (e.g., the computing device 140-a, 140-b, or 140-c) associated with the blockchain network 105 executes or completes a transaction associated with a token supported by the blockchain ledger, the nodes 145 of the blockchain network 105 may execute a transfer instruction that broadcasts the transaction (e.g., data associated with the transaction) to the other nodes 145 of the blockchain network 105, which may execute the blockchain application to verify the transaction and add the transaction to a new block (e.g., the block 120-d) of a blockchain ledger (e.g., the blockchain ledger 115) of transactions after verification of the transaction. Using the implemented consensus mechanism, each node 145 may function to support maintaining an accurate blockchain ledger 115 and prevent fraudulent transactions.

The blockchain ledger 115 may include a record of each transaction (e.g., a transaction 125) between wallets (e.g., wallet addresses) associated with the blockchain network 105. Some blockchains may support smart contracts, such as smart contract 130, which may be an example of a sub-program that may be deployed to the blockchain and executed when one or more conditions defined in the smart contract 130 are satisfied. For example, the nodes 145 of the blockchain network 105 may execute one or more instructions of the smart contract 130 after a method or instruction defined in the smart contract 130 is called by another device. In some examples, the blockchain ledger 115 is referred to as a blockchain distributed data store.

A computing device 140 may be used to input information to or receive information from the computing system custodial token platform 110, the blockchain network 105, or both. For example, a user of the computing device 140-a may provide user inputs via the computing device 140-a, which may result in commands, data, or any combination thereof being communicated via the network 135 to the computing system custodial token platform 110, the blockchain network 105, or both. Additionally, or alternatively, a computing device 140-a may output (e.g., display) data or other information received from the custodial token platform 110, the blockchain network 105, or both. A user of a computing device 140-a may, for example, use the computing device 140-a to interact with one or more user interfaces (e.g., graphical user interfaces (GUIs)) to operate or otherwise interact with the custodial token platform 110, the blockchain network 105, or both.

A computing device 140 and/or a node 145 may be a stationary device (e.g., a desktop computer or access point) or a mobile device (e.g., a laptop computer, tablet computer, or cellular phone). In some examples, a computing device 140 and/or a node 145 may be a commercial computing device, such as a server or collection of servers. And in some examples, a computing device 140 and/or a node 145 may be a virtual device (e.g., a virtual machine).

Some blockchain protocols may have layer two and layer two functionality, and each layer may support or utilize different tokens. Layer one may refer to the underlying main blockchain architecture, and layer one solutions are improvements directly integrated into the codebase of a cryptocurrency's main blockchain. Layer one solutions, on the other hand, are built on top of layer one and may interact with the main blockchain but have their own architecture. Layer two solutions may support offload of processing from the main blockchain (layer one) to improve scalability and speed while retaining the robust security of the main chain. Additionally, smart contracts implemented on the blockchain networks may support different types of tokens, and the code of the smart contracts may control how tokens are spent, who can spend the tokens, and other conditions for transfer. Additionally, one or more smart contracts may support a decentralized application (“Dapp”) that facilitate various types of functionality. Accordingly, various types of tokens may be supported by a blockchain network.

The custodial token platform 110 may support exchange or trading of digital assets, fiat currencies, or both by users of the custodial token platform 110. The custodial token platform 110 may be accessed via website, web application, or applications that are installed on the one or more computing devices 140. The custodial token platform 110 may be configured to interact with one or more types of blockchain networks, such as the blockchain network 105, to support digital asset purchase, exchange, deposit, and withdrawal.

For example, users may create accounts associated with the custodial token platform 110 such as to support purchasing of a digital asset via a fiat currency, selling of a digital asset via fiat currency, or exchanging or trading of digital assets. A key management service (e.g., a key manager) of the custodial token platform 110 may create, manage, or otherwise use private keys that are associated with user wallets and internal wallets. For example, if a user wishes to withdraw a token associated with the user account to an external wallet address, key manager 180 may sign a transaction associated with a wallet of the user, and broadcast the signed transaction to nodes 145 of the blockchain network 105, as described herein. In some examples, a user does not have direct access to a private key associated with a wallet or account supported or managed by the custodial token platform 110. As such, user wallets of the custodial token platform 110 may be referred to non-custodial wallets or non-custodial addresses.

The custodial token platform 110 may create, manage, delete, or otherwise use various types of wallets to support digital asset exchange. For example, the custodial token platform 110 may maintain one or more internal cold wallets 150. The internal cold wallets 150 may be an example of an offline wallet, meaning that the cold wallet 150 is not directly coupled with other computing systems or the network 135 (e.g., at all times). The cold wallet 150 may be used by the custodial token platform 110 to ensure that the custodial token platform 110 is secure from losing assets via hacks or other types of unauthorized access and to ensure that the custodial token platform 110 has enough assets to cover any potential liabilities. The one or more cold wallets 150, as well as other wallets of the blockchain network 105 may be implemented using public key cryptography, such that the cold wallet 150 is associated with a public key 155 and a private key 160. The public key 155 may be used to publicly transact via the cold wallet 150, meaning that another wallet may enter the public key 155 into a transaction such as to move assets from the wallet to the cold wallet 150. The private key 160 may be used to verify (e.g., digitally sign) transactions that are transmitted from the cold wallet 150, and the digital signature may be used by nodes 145 to verify or authenticate the transaction. Other wallets of the custodial token platform 110 and/or the blockchain network 105 may similarly use aspects of public key cryptography.

The custodial token platform 110 may also create, manage, delete, or otherwise use inbound wallets 165 and outbound wallets 170. For example, a wallet manager 175 of the custodial token platform 110 may create a new inbound wallet 165 for each user or account of the custodial token platform 110 or for each inbound transaction (e.g., deposit transaction) for the custodial token platform 110. In some examples, the custodial token platform 110 may implement techniques to move digital assets between wallets of the digital asset exchange platform. Assets may be moved based on a schedule, based on asset thresholds, liquidity requirements, or a combination thereof. In some examples, movements or exchanges of assets internally to the custodial token platform 110 may be “off-chain” meaning that the transactions associated with the movement of the digital asset are not broadcast via the corresponding blockchain network (e.g., blockchain network 105). In such cases, the custodial token platform 110 may maintain an internal accounting (e.g., ledger) of assets that are associated with the various wallets and/or user accounts.

As used herein, a wallet, such as inbound wallets 165 and outbound wallets 170 may be associated with a wallet address, which may be an example of a public key, as described herein. The wallets may be associated with a private key that is used to sign transactions and messages associated with the wallet. A wallet may also be associated with various user interface components and functionality. For example, some wallets may be associated with or leverage functionality for transmitting crypto tokens by allowing a user to enter a transaction amount, a receiver address, etc. into a user interface and clicking or activating a UI component such that the transaction is broadcast via the corresponding blockchain network via a node (e.g., a node 145) associated with the wallet. As used herein, “wallet” and “address” may be used interchangeably.

In some cases, the custodial token platform 110 may implement a transaction manager 185 that supports monitoring of one or more blockchains, such as the blockchain ledger 115, for incoming transactions associated with addresses managed by the custodial token platform 110 and creating and broadcasting on-blockchain transactions when a user or customer sends a digital asset (e.g., a withdrawal). For example, the transaction manager 185 may monitor the addressees of the customers for transfer of layer one or layer two tokens supported by the blockchain ledger 115 to the addresses managed by the custodial token platform 110. As another example, when a user is withdrawing a digital asset, such as a layer one or layer two token, to an external wallet (e.g., an address that is not managed by the custodial token platform 110 or an address for which the custodial token platform 110 does not have access to the associated private key), the transaction manager 185 may create and broadcast the transaction to one or more other nodes 145 of the blockchain network 105 in accordance with the blockchain application associated with the blockchain network 105. As such, the transaction manager 185, or an associated component of the custodial token platform 110 may function as a node 145 of the blockchain network 105.

As described herein, the custodial token platform may implement and support various wallets including the inbound wallets 165, the outbound wallets 170, and the cold wallets 150. Further, the custodial token platform 110 may implement techniques to maintain and manage balances of the various wallets. In some examples, the balances of the various wallets are configured to support security and liquidity. For example, the custodial token platform 110 may implement transactions that move crypto tokens between the inbound wallets 165 and the outbound wallets 170. These transactions may be referred to as “flush” transactions and may occur on a periodic or scheduled basis.

As described herein, various transactions may be broadcast to the blockchain ledger 115 to cause transfer of crypto tokens, to call smart contracts, to deploy smart contracts etc. In some examples, these transactions may also be referred to as messages. That is, the custodial token platform 110 may broadcast a message to the blockchain network 105 to cause transfer of tokens between wallets managed by the custodial token platform 110 to an external wallet, to deploy a smart contract (e.g., a self-executing program), or to call a smart contract.

In some systems, multiple parties in an MPC scheme may collaborate to perform an MPC operation. As part of the MPC scheme, a cryptographic key may be distributed, via multiple key shares, to multiple parties. For example, a cryptographic key (e.g., private key 160), which may be an example of a secret signing key or a secret decryption key, may be split into multiple parts via a key sharing operation. In some cases, a threshold quantity or all of the multiple parties having the key shares of the cryptographic key (i.e., t out of n key shares) may, together, perform an MPC operation. In other words, the threshold quantity of key shares may be required to execute the MPC operation. Additionally, each key share may include a public key share, used for encryption, and a private key share, used for decryption and kept secret at each entity. Distributing the key as key shares across multiple parties may improve security and reduce the vulnerability of the key, as an attacker may need to attack all parties or a threshold quantity of parties holding key shares in order to use the key.

In some cases, an entity, such as an auditor, may request proof of possession of assets associated with the key for the parties. For example, for a blockchain network 105, a key may be associated with a blockchain address including one or more assets (e.g., the blockchain address of the cold wallet 150). The key (e.g., the private key 160) may be used to control and access the assets. The auditor may request a proof of possession for the blockchain address. Proof of possession for the blockchain address may include proof of possession of a cryptographic key associated with the blockchain address. To verify that a user, platform, or the like may hold the cryptographic keys associated with the blockchain address, the owner may send a signed audit message to the auditor. For example, in an MPC scheme, the parties may perform a cryptographic operation to generate a signature for an audit message using at least the threshold quantity of key shares. The auditor may receive the signed output, which may prove that the parties possess the blockchain address based on the control of the associated private key used to generate the valid signature.

However, performing a cryptographic operation to generate the proof of possession (e.g., the signed audit messages) may be associated with one or more security risks. For example, the key shares may be brought online, or made accessible at a network 135, to perform the operation, which may expose the key shares to attackers. Additionally, or alternatively, the proof of possession message, which may be a signed message, may be similar or identical to a transaction message. A transaction message may be used to transfer or control assets via the blockchain network 105. An attacker may intercept the signed audit message, including the valid signature, and may use it to transfer or control the associated assets. For example, the attacker may change the signed audit message to a transaction message to steal funds (e.g., by broadcasting the signed transaction via the blockchain network 105). Additionally, or alternatively, performing a cryptographic operation to sign the audit message, such as via a threshold signing scheme, may be computationally expensive and time consuming.

As described herein, each party may independently generate outputs for a cryptographic operation using a respective private key share, where the outputs may be sufficient to act as proof of possession for a blockchain address, but may be insufficient to construct a verifiable signature for the blockchain address. For example, an auditor may request proof of possession of a blockchain address. A facilitator, such as a lead party, a server, or a platform (e.g., custodial token platform 110), may receive the request and may transmit, to each party that holds a key share, a request to perform a cryptographic operation associated with the audit message and using the respective private key shares. Each party may, independently, perform the cryptographic operation and generate an output. For example, the cryptographic operation may be a signing operation. Each party may sign an audit message with a signature based on the key share that it possesses, rather than generating a full signature. The facilitator may receive the outputs of the cryptographic operation (e.g., the signed audit messages) and may send the outputs and associated public key shares to the auditor. The auditor may verify that the individual outputs are a valid output for a cryptographic operation corresponding to the public key (e.g., formed with the associated public key shares).

By performing the cryptographic operation to generate a proof of possession for a blockchain address with key shares independently at each party, the key shares may not be brought online, which may reduce the exposure and vulnerability of the key shares, while increasing the security of the system. Additionally, or alternatively, by using a key share to perform the cryptographic operation, as opposed to a full key, the outputs generated at each party, such as the signed audit messages, may not be valid signatures for the corresponding public key. For example, the signed audit messages may not be intercepted and changed to transaction messages by an attacker, as the signatures may not be valid transaction signatures. Additionally, or alternatively, performing cryptographic operations independently at the parties may be less computationally expensive than performing a joint MPC operation.

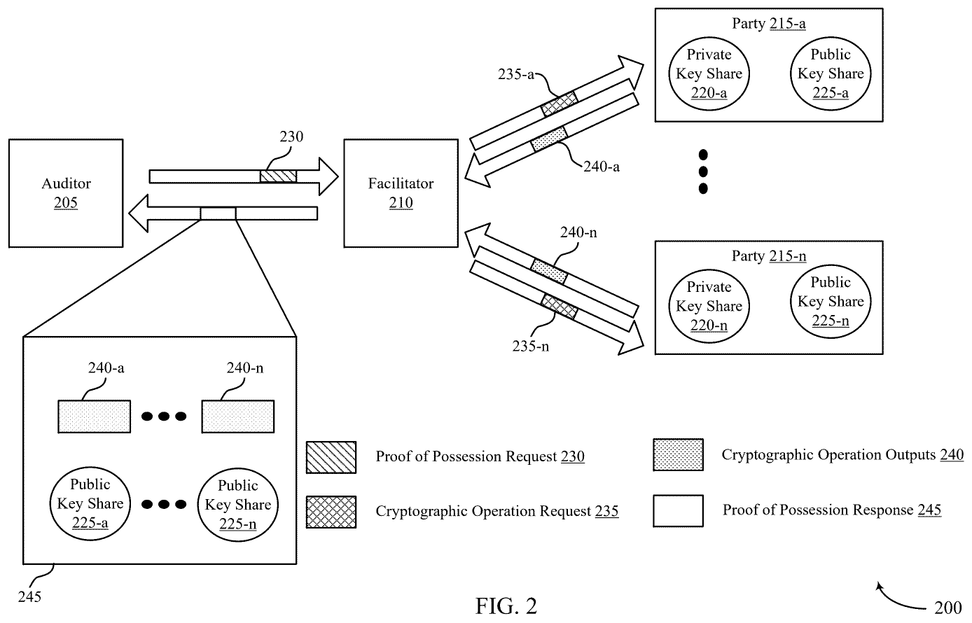

FIG. 2 shows an example of a signaling environment 200 that supports distributed proofs of possession for auditing private keys in accordance with aspects of the present disclosure. The signaling environment 200 may implement or be implemented to realize aspects of the computing environment 100. Signaling environment 200 may support performing, independently at parties 215 for an MPC system, a cryptographic operation to generate a proof of possession of a blockchain address using key shares held by each party 215.

In some systems, multiple parties 215 in a multi-party computation (MPC) scheme may collaborate to perform an MPC operation. As part of the MPC scheme, a cryptographic key may be distributed, via multiple key shares, to the multiple parties 215. For example, a cryptographic key, which may be an example of a secret signing key or a secret decryption key, may be split into multiple parts via a key sharing operation. In some cases, the cryptographic key may be a private/public key pair. For example, the cryptographic key may include a private key and an associated public key. The public key may be related to the private key based on a generator function (e.g., G). For example, the public key, Q, may be formed by applying the generator function to the private key (e.g., Q=x·G). For an MPC scheme, the parties 215 may hold a respective private key share 220 and an associated respective public key share 225 for the cryptographic key. For example, party 215-a may have a private key share 220-a and a public key shares 225-a, while party 215-n may have a private key share 220-n and a public key share 225-n. The private key shares 220 may be related to the public key shares based on the generator function (e.g., Qᵢ=xᵢ·G, Qᵢ may be a respective public key share 225, xᵢ may be a respective private key share 220, and G may be the generator function). For additive key sharing, the private key, x, may be formed by summing all the private key shares 220. For threshold key sharing, the private key, x, may be formed based on applying a polynomial operation or interpolation to the private key shares 220.

In some cases, an entity, such as an auditor 205, may request proof of possession of a blockchain address. In a blockchain system, the blockchain address, which may correspond to some assets, may be accessed or controlled by a cryptographic key. The auditor 205 may request a proof of possession for the blockchain address. Proof of possession for the blockchain address may be provided by verifying that the parties 215 possess the private key shares 220 and public key shares 225 for accessing the blockchain address. In some examples, to verify that a user, platform, or MPC group may possess the cryptographic key associated with the blockchain address, the facilitator 210 may send a signed audit message to the auditor 205. For example, in an MPC scheme, the parties may perform a cryptographic operation to generate a signature for an audit message using at least a threshold quantity of private key shares 220. The auditor may receive the signed output, which may prove that the parties possess the blockchain address based on control of the associated cryptographic key used to generate the valid signature.

However, performing a cryptographic operation to generate the proof of possession (e.g., the signed audit messages) may be associated with one or more security risks. For example, the key shares may be brought online, or made accessible by a network, to perform the operation, which may expose the key to attackers. Additionally, or alternatively, the proof of possession message, which may be a signed message, may be similar or identical to a transaction message. A transaction message may be used to transfer or control assets. An attacker may intercept the signed audit message, including the valid signature, and may use it to transfer or control the associated assets. For example, the attacker may change the signed audit message to a transaction message to steal funds. Additionally, or alternatively, performing a cryptographic operation to sign the audit message, such as via a threshold signing scheme, may be computationally expensive and time consuming.

In some cases, instead of using a full key (or a threshold quantity of private key shares 220) to generate a proof of possession (e.g., sign an audit message), each party 215 may perform a cryptographic operation using a respective private key share 220. For example, an auditor 205 may transit a proof of possession request 230 to a facilitator 210. The facilitator 210 may be a server, a platform, a lead party 215, or any combination thereof. The facilitator 210 may request that each party 215 that may hold a private key share 220 may perform a cryptographic operation. That is, the facilitator 210 may send cryptographic operation requests 235 to the parties 215. The parties may perform the cryptographic operation and may generate some cryptographic operation outputs 240, which the parties 215 may output to the facilitator 210 or directly to the auditor 205. The facilitator 210 may transmit, to the auditor 205, a proof of possession response 245. The proof of possession response may include the cryptographic operation outputs 240 and the associated public key shares 225. The auditor 205 may verify the cryptographic operation outputs 240 based on the public key shares 225.

In some examples, the cryptographic operation may be a signing operation. For example, the cryptographic operation outputs 240 may be signed audit messages. The cryptographic operation request 235 may be a request to generate a signed audit message. For example, each party 215 may possess a private key share 220 (e.g., xᵢ) and associated public key shares 225(e.g., Qᵢ). Each party 215 (e.g., Pᵢ) may sign an audit message using the respective private key share 220 and may output the signature (e.g., sᵢ). For example, party 215-a may use the private key share 220-a to generate a signature and sign the audit message. Party 215-n may use the private key share 220-n to generate a signature and sign the audit message. In some cases, additional parties 215 may use respective private key shares 220 to generate signatures and sign the audit messages. In some cases, the signing key (e.g., the private key share 220) may be an Edwards-curve digital signature algorithm (EdDSA) key, and the parties 215 may generate EdDSA signatures. in other cases, the signing key may be an elliptic curve digital signature algorithm (ECDSA) key, and the parties may generate standard Schnorr signatures.

The auditor 205 may receive the proof of possession response 245, which may include the public key shares 225 and the cryptographic operation outputs 240. The auditor 205 may verify that each cryptographic operation output 240 is valid. For example, for signed audit messages, the auditor 205 may verify that each signature may be a valid signature for the audit message based on the associated public key share 225. In some examples, the auditor 205 may also verify that the public key shares 225 may form the public key. For example, for an additive MPC system, the auditor 205 may ensure that the public key shares 225 add together to form the public key. In some examples, the facilitator 210 may indicate the public key to the auditor 205.

In some cases, a threshold quantity of the multiple parties 215 having the key shares of the cryptographic key (i.e., t out of n key shares) may, together, perform an MPC operation. In other words, the threshold quantity of key shares (e.g., private key shares 220 and public key shares 225) may be required to execute the MPC operation. In some examples, the cryptographic operation may be a full threshold operation, where the threshold quantity of the multiple parties may be all of the parties 215 having the key shares. In other examples, the cryptographic operation may be a partial threshold operation, where a subset of parties 215 may be required to participate in the cryptographic operation. Key shares for a threshold MPC system may be generated using a polynomial operation (e.g., as opposed to additively combinable key shares).

In some cases, for threshold MPC operations, an auditor 205 may verify whether the parties 215 each hold a valid portion of the private key share 220. For example, each private key share 220 may be associated with a respective public key share 225 according to the generator function. In some examples, constructing the public key shares 225 may include polynomial evaluation, polynomial interpolation, or both of public values associated with verifiable secret sharing. For example, if the verifiable secret sharing to divide the key between the parties 215 is in accordance with a polynomial implementation, the associated public key shares 225 may be similarly constructed. Each party 215 may generate a signature using an associated private key share 220 and may send the signed audit messages to the facilitator or the auditor. In some cases, the signature may be a Lagrange interpolation, polynomial evaluation, or any combination thereof. The auditor may verify that each signature is valid under the public key.

Additionally, or alternatively, the auditor 205 may verify whether the parties 215 hold at least the threshold quantity of private key shares 220. For example, for a partial threshold MPC system, a subset of parties 215 may generate a valid signature for a cryptographic operation. In some cases, some parties 215 may not be available to perform the cryptographic operation in response to the cryptographic operation request 235. For a partial threshold scheme, the subset of parties 215 may be required for a proof of possession response 245. For example, each available party 215 may generate a cryptographic operation output 240, such as a signature, using a respective private key share 220, as described herein. The facilitator 210 may transmit the proof of possession response including the cryptographic operation outputs 240 for the available parties 215. The auditor 205 may verify that the quantity of cryptographic operation outputs 240 received in the proof of possession response 245 satisfies the threshold quantity of private key shares 220. The auditor 205 may also verify that each cryptographic operation output 240 may be a valid output for the cryptographic operation associated with the respective public key shares 225. In some examples, the facilitator may indicate the threshold quantity of private key shares 220 to the auditor 205.

By performing the cryptographic operations separately at each party 215, such that the private key shares are used separately, the private key shares 220 may not be brought online, reducing exposure of the private key shares 220 and improving security. Additionally, or alternatively, the signatures generated using the private key share 220, and not the full key or the threshold quantity of private key shares 220, may not be valid signatures under the full public key (e.g., Schnorr proof) and may not be changed into valid transaction messages by an attacker. Signatures associated with the public key shares 225, however, may not be generated without access to the associated private key share 220 (e.g., signing scheme is unforgeable). Thus, the signatures using the key shares, instead of the full key, still act as a proof of possession or the blockchain address.

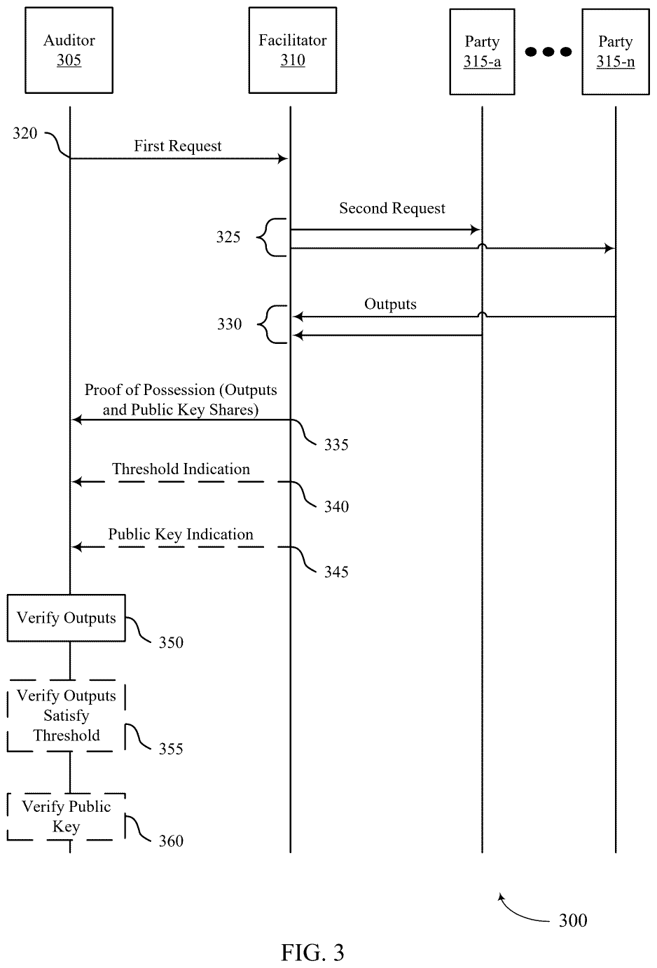

FIG. 3 shows an example of a process flow 300 that supports distributed proofs of possession for auditing private keys in accordance with aspects of the present disclosure. The process flow 300 may implement or be implemented to realize aspects of the computing environment 100 and the signaling environment 200. Process flow 300 may support a proof of possession for a blockchain address based on cryptographic operation outputs using key shares.

At 320, an auditor 305 may transmit a first request (e.g., proof of possession request 230) for a proof of possession of a blockchain address that may be associated with a public key, where the first request may include an audit message to be used to complete the proof of possession of the blockchain address and using a private key associated with the blockchain address. A facilitator 310 may receive the first request. The facilitator 310 may be a server, platform, user, lead party 315, or any combination thereof.

At 325, the facilitator 310 may transmit, to each party 315 (e.g., entity) of multiple parties 315 each possessing a respective private key share of multiple private key shares of the private key, a second request (e.g., cryptographic operation request 235) to perform a cryptographic operation associated with the audit message and using the respective private key share. In some cases, the facilitator may transmit, to each party 315 of the multiple parties 315, the second request to sign the audit message using the respective private key share, where the cryptographic operation may include signing the audit message.

At 330, the facilitator 310 may receive, after transmitting the second request and from at least a portion of the multiple entities, multiple outputs (e.g., cryptographic operation outputs 240) associated with the cryptographic operation and the multiple private key shares, where the multiple outputs may be insufficient to construct a verifiable signature for the blockchain address. In some cases, the multiple outputs may include multiple signed audit messages. In some cases, the multiple outputs may satisfy a threshold quantity of outputs, where a respective signature of the multiple outputs may be associated with the public key. In some cases, the private key may be an EdDSA key and the multiple outputs may be generated using the EdDSA and the respective private key shares. In other cases, the private key may be an ECDSA key and the plurality of outputs may be generated using Schnorr signatures and the respective private key shares.

At 335, the facilitator may output, in response to the first request, the multiple outputs and a respective multiple public key shares of the public key (e.g., proof of possession response 245), where the multiple outputs and the respective multiple public key shares may form the proof of possession of the blockchain address. The auditor 305 may receive the proof of possession (e.g., the multiple outputs and the respective multiple public key shares of the public key). In some cases, the public key shares of the respective multiple public key shares may be additively combinable to form the public key.

In some cases, at 340, the facilitator 310 may output, and the auditor 305 may receive an indication of the threshold quantity of outputs. Although the signaling at 340 is illustrated after the proof of possession at 335, the indication of the threshold quantity of outputs at 340 and the proof of possession at 335 may be transmitted in any order. Additionally, or alternatively, the indication of the threshold quantity of outputs may be transmitted any time after receiving the first request at 320.

In some cases, at 345, the facilitator 310 may output, and the auditor 305 may receive, an indication of the public key. Although the signaling at 345 is illustrated after the proof of possession at 335, the indication of the public key at 345 and the proof of possession at 335 may be transmitted in any order. Additionally, or alternatively, the indication of the public key may be transmitted any time after receiving the first request at 320.

At 350, the auditor 305 may verify that each of the multiple outputs may be a valid output of the cryptographic operation for the public key. In some cases, the multiple outputs may include the multiple signed audit messages that are signed with the respective key shares of the private key. In some cases, at 350, the auditor 305 may verify that each of the multiple signed audit messages are a valid signature for the public key. In some cases, to verify that each of the multiple outputs may be a valid output of the cryptographic operation for the public key, the auditor may verify that each of the multiple outputs may be the valid signature using an EdDSA. In other cases, to verify that each of the multiple outputs may be a valid output of the cryptographic operation for the public key, the auditor may verify that each of the multiple outputs may be the valid signature using an ECDSA.

In some cases, at 355, the auditor 305 may verify that the multiple outputs may satisfy a threshold quantity of outputs. For example, the auditor 305 may verify that the multiple outputs may satisfy the threshold quantity of outputs based on receiving the indication of the threshold quantity at 340.

In some cases, at 360, the auditor 305 may verify that the respective multiple public key shares may form the public key. In some examples, the auditor 305 may verify that the respective multiple public key shares form the public key by adding together the respective multiple public key shares to form the public key (e.g., additive key sharing). Verifying that the respective multiple public key shares form the public key may be based on receiving the indication of the public key at 345.

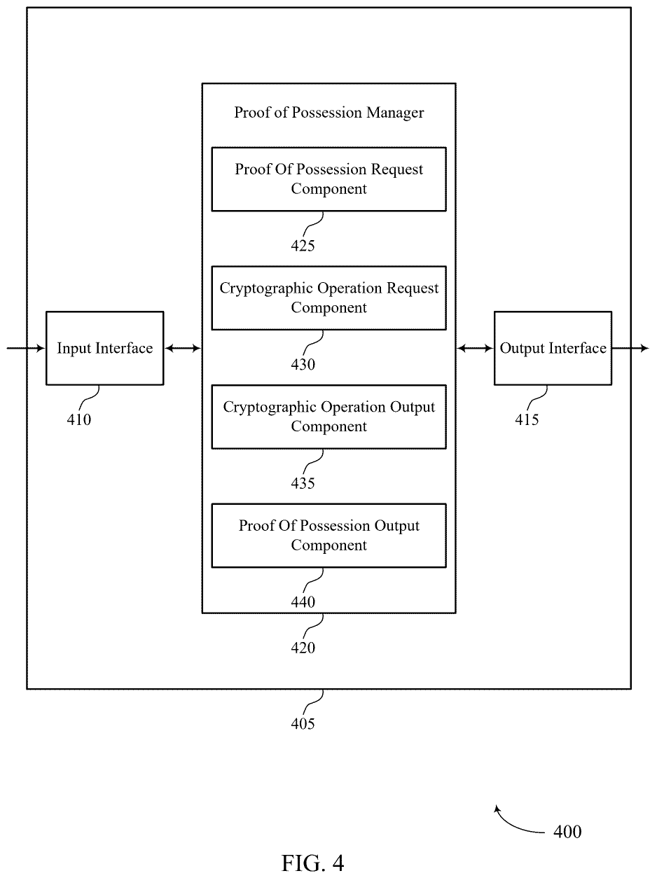

FIG. 4 shows a block diagram 400 of a system 405 that supports distributed proofs of possession for auditing private keys in accordance with aspects of the present disclosure. The system 405 may include an input interface 410, an output interface 415, and a proof of possession manager 420. The system 405, or one or more components of the system 405 (e.g., the input interface 410, the output interface 415, the proof of possession manager 420), may include at least one processor, which may be coupled with at least one memory, to support the described techniques. Each of these components may be in communication with one another (e.g., via one or more buses).

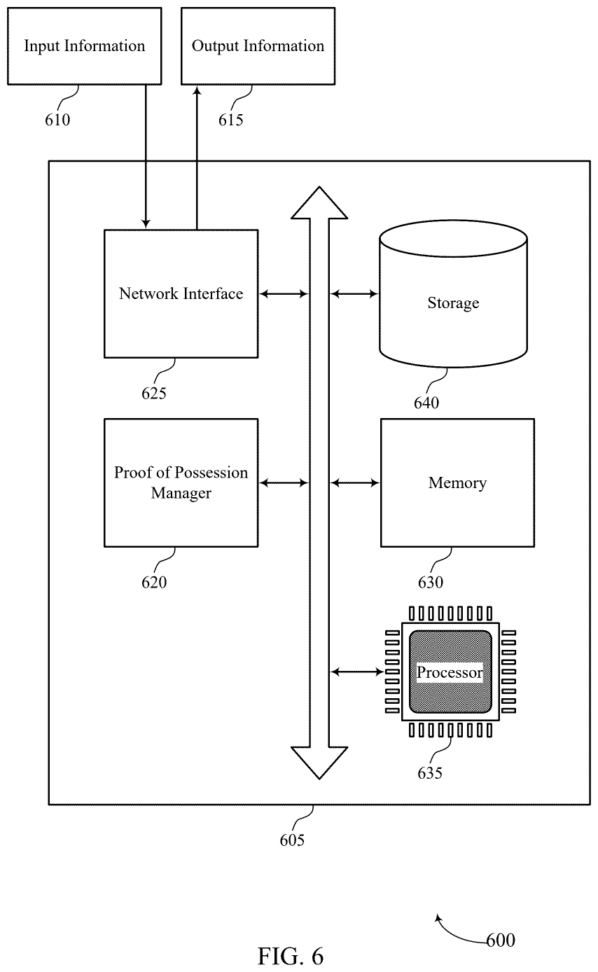

The input interface 410 may manage input signaling for the system 405. For example, the input interface 410 may receive input signaling (e.g., messages, packets, data, instructions, commands, transactions, or any other form of encoded information) from other systems or devices. The input interface 410 may send signaling corresponding to (e.g., representative of or otherwise based on) such input signaling to other components of the system 405 for processing. For example, the input interface 410 may transmit such corresponding signaling to the proof of possession manager 420 to support distributed proofs of possession for auditing private keys. In some cases, the input interface 410 may be a component of a network interface 625 as described with reference to FIG. 6.

The output interface 415 may manage output signaling for the system 405. For example, the output interface 415 may receive signaling from other components of the system 405, such as the proof of possession manager 420, and may transmit such output signaling corresponding to (e.g., representative of or otherwise based on) such signaling to other systems or devices. In some cases, the output interface 415 may be a component of a network interface 625 as described with reference to FIG. 6.

For example, the proof of possession manager 420 may include a proof of possession request component 425, a cryptographic operation request component 430, a cryptographic operation output component 435, a proof of possession output component 440, or any combination thereof. In some examples, the proof of possession manager 420, or various components thereof, may be configured to perform various operations (e.g., receiving, monitoring, transmitting) using or otherwise in cooperation with the input interface 410, the output interface 415, or both. For example, the proof of possession manager 420 may receive information from the input interface 410, send information to the output interface 415, or be integrated in combination with the input interface 410, the output interface 415, or both to receive information, transmit information, or perform various other operations as described herein.

The proof of possession request component 425 may be configured as or otherwise support a means for receiving a first request for a proof of possession of a blockchain address that is associated with a public key, wherein the first request includes an audit message to be used to complete the proof of possession of the blockchain address and using a private key associated with the blockchain address. The cryptographic operation request component 430 may be configured as or otherwise support a means for transmitting, to each entity of a plurality of entities each possessing a respective private key share of a plurality of private key shares of the private key, a second request to perform a cryptographic operation associated with the audit message and using the respective private key share. The cryptographic operation output component 435 may be configured as or otherwise support a means for receiving, after transmitting the second request and from at least a portion of the plurality of entities, a plurality of outputs associated with the cryptographic operation and the plurality of private key shares, wherein the plurality of outputs is insufficient to construct a verifiable signature for the blockchain address. The proof of possession output component 440 may be configured as or otherwise support a means for outputting, in response to the first request, the plurality of outputs and a respective plurality of public key shares of the public key, wherein the plurality of outputs and the respective plurality of public key shares form the proof of possession of the blockchain address.

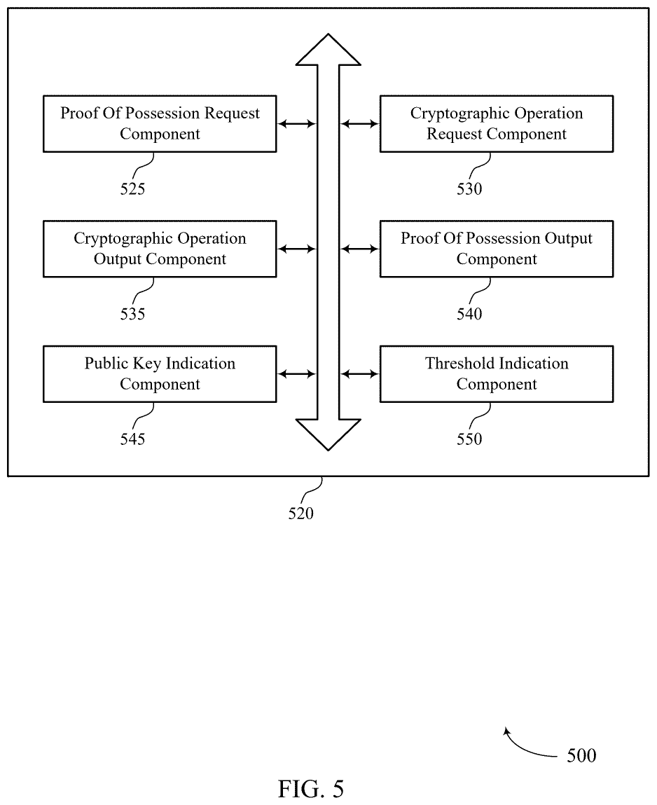

FIG. 5 shows a block diagram 500 of a proof of possession manager 520 that supports distributed proofs of possession for auditing private keys in accordance with aspects of the present disclosure. The proof of possession manager 520 may be an example of aspects of a proof of possession manager or a proof of possession manager 420, or both, as described herein. The proof of possession manager 520, or various components thereof, may be an example of means for performing (e.g., to cause the proof of possession manager 520 to perform) various aspects of distributed proofs of possession for auditing private keys as described herein. For example, the proof of possession manager 520 may include a proof of possession request component 525, a cryptographic operation request component 530, a cryptographic operation output component 535, a proof of possession output component 540, a public key indication component 545, a threshold indication component 550, or any combination thereof. Each of these components, or components of subcomponents thereof (e.g., one or more processors, one or more memories), may communicate, directly or indirectly, with one another (e.g., via one or more buses).

The proof of possession request component 525 may be configured as or otherwise support a means for receiving a first request for a proof of possession of a blockchain address that is associated with a public key, wherein the first request includes an audit message to be used to complete the proof of possession of the blockchain address and using a private key associated with the blockchain address. The cryptographic operation request component 530 may be configured as or otherwise support a means for transmitting, to each entity of a plurality of entities each possessing a respective private key share of a plurality of private key shares of the private key, a second request to perform a cryptographic operation associated with the audit message and using the respective private key share. The cryptographic operation output component 535 may be configured as or otherwise support a means for receiving, after transmitting the second request and from at least a portion of the plurality of entities, a plurality of outputs associated with the cryptographic operation and the plurality of private key shares, wherein the plurality of outputs is insufficient to construct a verifiable signature for the blockchain address. The proof of possession output component 540 may be configured as or otherwise support a means for outputting, in response to the first request, the plurality of outputs and a respective plurality of public key shares of the public key, wherein the plurality of outputs and the respective plurality of public key shares form the proof of possession of the blockchain address.

In some examples, the plurality of outputs may include a plurality of signed audit messages and, to support transmitting the second request, the cryptographic operation request component 530 may be configured as or otherwise support a means for transmitting, to each entity of the plurality of entities each possessing the respective private key share of the private key, the second request to sign the audit message using the respective private key share, wherein the cryptographic operation includes signing the audit message.

In some examples, public key shares of the respective plurality of public key shares are additively combinable to form the public key.

In some examples, the plurality of outputs satisfies a threshold quantity of outputs. In some examples, a respective signature of the plurality of outputs is associated with the public key.

In some examples, the threshold indication component 550 may be configured as or otherwise support a means for outputting an indication of the threshold quantity of outputs.

In some examples, the public key indication component 545 may be configured as or otherwise support a means for outputting an indication of the public key.

In some examples, the private key is an Edwards-curve digital signature algorithm (EdDSA) key and the plurality of outputs are generated using the EdDSA and the respective private key shares.

In some examples, the private key is an elliptic curve digital signature algorithm (ECDSA) key and the plurality of outputs are generated using Schnorr signatures and the respective private key shares.

FIG. 6 shows a diagram of a system 600 including a system 605 that supports distributed proofs of possession for auditing private keys in accordance with aspects of the present disclosure. The system 605 may be an example of or include components of a system 405 as described herein. The system 605 may include components for bi-directional voice and data communications including components for transmitting and receiving communications, such as a proof of possession manager 620, an input information 610, an output information 615, a network interface 625, at least one memory 630, at least one processor 635, and a storage 640. Each of these components, or components of subcomponents thereof (e.g., one or more processors, one or more memories), may communicate, directly or indirectly, with one another (e.g., via one or more buses).

The network interface 625 may enable the system 605 to exchange information (e.g., input information 610, output information 615, or both) with other systems or devices (not shown). For example, the network interface 625 may enable the system 605 to connect to a network (e.g., a network 135 as described herein). The network interface 625 may include one or more wireless network interfaces, one or more wired network interfaces, or any combination thereof.

Memory 630 may include RAM, ROM, or both. The memory 630 may store computer-readable, computer-executable software including instructions that, when executed, cause at least one processor 635 to perform various functions described herein, such as functions supporting distributed proofs of possession for auditing private keys. In some cases, the memory 630 may contain, among other things, a basic input/output system (BIOS), which may control basic hardware or software operation such as the interaction with peripheral components or devices. In some cases, the memory 630 may be an example of aspects of one or more components of a custodial token platform 110 as described with reference to FIG. 1. The memory 630 may be an example of a single memory or multiple memories. For example, the system 605 may include one or more memories 630.

The processor 635 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 635 may be configured to execute computer-readable instructions stored in at least one memory 630 to perform various functions (e.g., functions or tasks supporting distributed proofs of possession for auditing private keys). Though a single processor 635 is depicted in the example of FIG. 6, it is to be understood that the system 605 may include any quantity of one or more of processors 635 and that a group of processors 635 may collectively perform one or more functions ascribed herein to a processor, such as the processor 635. The processor 635 may be an example of a single processor or multiple processors. For example, the system 605 may include one or more processors 635.

Storage 640 may be configured to store data that is generated, processed, stored, or otherwise used by the system 605. In some cases, the storage 640 may include one or more HDDs, one or more SDDs, or both. In some examples, the storage 640 may be an example of a single database, a distributed database, multiple distributed databases, a data store, a data lake, or an emergency backup database. In some examples, the storage 640 may be an example of one or more components described with reference to FIG. 1.

For example, the proof of possession manager 620 may be configured as or otherwise support a means for receiving a first request for a proof of possession of a blockchain address that is associated with a public key, wherein the first request includes an audit message to be used to complete the proof of possession of the blockchain address and using a private key associated with the blockchain address. The proof of possession manager 620 may be configured as or otherwise support a means for transmitting, to each entity of a plurality of entities each possessing a respective private key share of a plurality of private key shares of the private key, a second request to perform a cryptographic operation associated with the audit message and using the respective private key share. The proof of possession manager 620 may be configured as or otherwise support a means for receiving, after transmitting the second request and from at least a portion of the plurality of entities, a plurality of outputs associated with the cryptographic operation and the plurality of private key shares, wherein the plurality of outputs is insufficient to construct a verifiable signature for the blockchain address. The proof of possession manager 620 may be configured as or otherwise support a means for outputting, in response to the first request, the plurality of outputs and a respective plurality of public key shares of the public key, wherein the plurality of outputs and the respective plurality of public key shares form the proof of possession of the blockchain address.

By including or configuring the proof of possession manager 620 in accordance with examples as described herein, the system 605 may support techniques for increased security, reduced exposure of key shares for a cryptographic key, reduced vulnerability of audit messages, and reduced energy consumption.

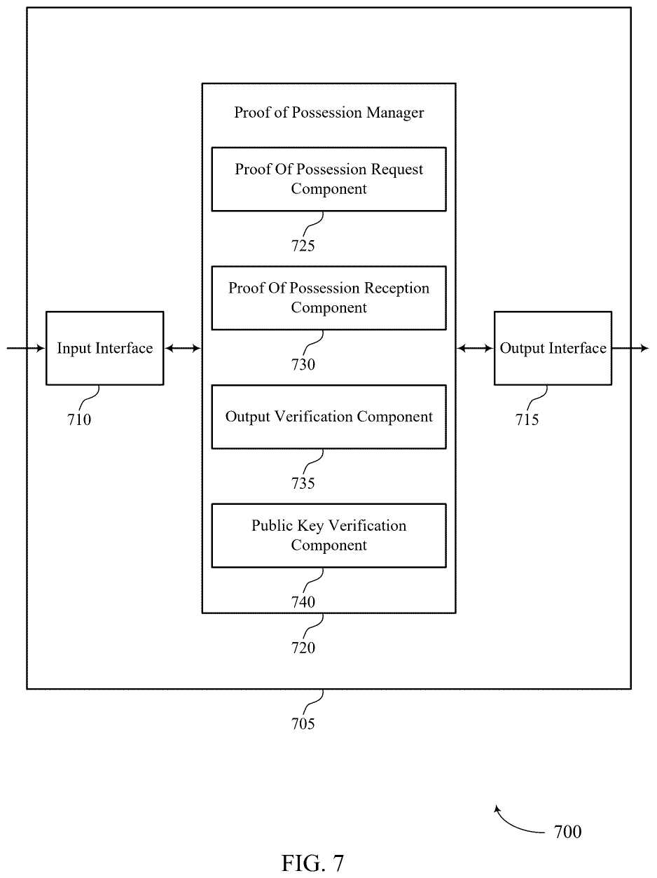

FIG. 7 shows a block diagram 700 of a system 705 that supports distributed proofs of possession for auditing private keys in accordance with aspects of the present disclosure. The system 705 may include an input interface 710, an output interface 715, and a proof of possession manager 720. The system 705, or one or more components of the system 705 (e.g., the input interface 710, the output interface 715, the proof of possession manager 720), may include at least one processor, which may be coupled with at least one memory, to support the described techniques. Each of these components may be in communication with one another (e.g., via one or more buses).

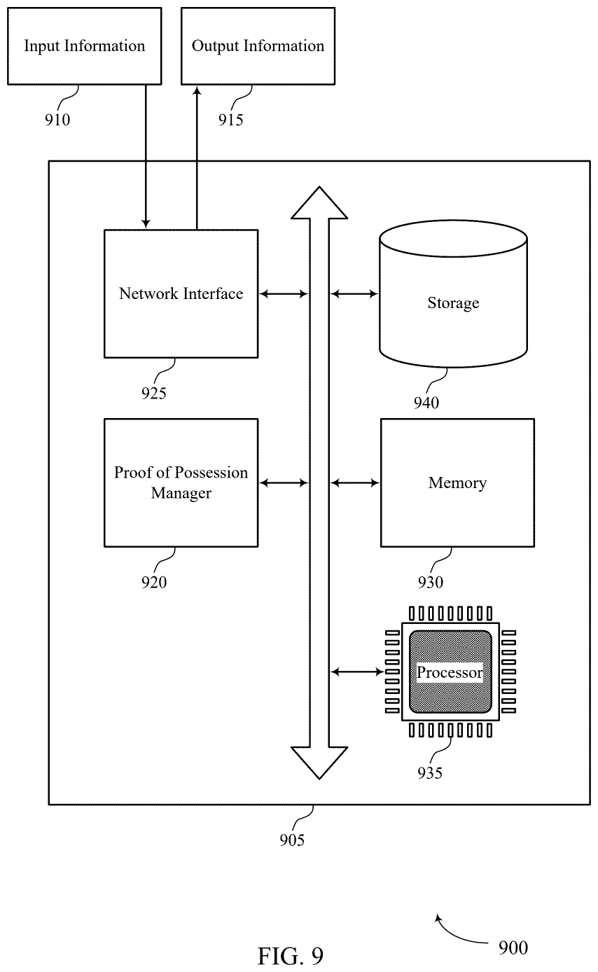

The input interface 710 may manage input signaling for the system 705. For example, the input interface 710 may receive input signaling (e.g., messages, packets, data, instructions, commands, transactions, or any other form of encoded information) from other systems or devices. The input interface 710 may send signaling corresponding to (e.g., representative of or otherwise based on) such input signaling to other components of the system 705 for processing. For example, the input interface 710 may transmit such corresponding signaling to the proof of possession manager 720 to support distributed proofs of possession for auditing private keys. In some cases, the input interface 710 may be a component of a network interface 925 as described with reference to FIG. 9.

The output interface 715 may manage output signaling for the system 705. For example, the output interface 715 may receive signaling from other components of the system 705, such as the proof of possession manager 720, and may transmit such output signaling corresponding to (e.g., representative of or otherwise based on) such signaling to other systems or devices. In some cases, the output interface 715 may be a component of a network interface 925 as described with reference to FIG. 9.

For example, the proof of possession manager 720 may include a proof of possession request component 725, a proof of possession reception component 730, an output verification component 735, a public key verification component 740, or any combination thereof. In some examples, the proof of possession manager 720, or various components thereof, may be configured to perform various operations (e.g., receiving, monitoring, transmitting) using or otherwise in cooperation with the input interface 710, the output interface 715, or both. For example, the proof of possession manager 720 may receive information from the input interface 710, send information to the output interface 715, or be integrated in combination with the input interface 710, the output interface 715, or both to receive information, transmit information, or perform various other operations as described herein.

The proof of possession request component 725 may be configured as or otherwise support a means for outputting a first request for a proof of possession of a blockchain address that is associated with a public key, wherein the first request includes an audit message to be used to complete the proof of possession of the blockchain address and using a private key associated with the blockchain address. The proof of possession reception component 730 may be configured as or otherwise support a means for receiving a plurality of outputs and a respective plurality of public key shares of the public key, wherein the plurality of outputs is associated with execution of a cryptographic operation using respective private key shares of a private key associated with the blockchain address, and wherein the plurality of outputs and the respective plurality of public key shares form the proof of possession of the blockchain address and wherein the plurality of outputs are insufficient to construct a verifiable signature for the blockchain address. The output verification component 735 may be configured as or otherwise support a means for verifying that each of the plurality of outputs are a valid output of the cryptographic operation for the public key.

The proof of possession request component 725 may be configured as or otherwise support a means for outputting a first request for a proof of possession of a blockchain address that is associated with a public key, wherein the first request includes an audit message to be used to complete the proof of possession of the blockchain address and using a private key associated with the blockchain address. The proof of possession reception component 730 may be configured as or otherwise support a means for receiving a plurality of outputs and a respective plurality of public key shares of the public key, wherein the plurality of outputs is associated with execution of a cryptographic operation using respective private key shares of a private key associated with the blockchain address, and wherein the plurality of outputs and the respective plurality of public key shares form the proof of possession of the blockchain address and wherein the plurality of outputs are insufficient to construct a verifiable signature for the blockchain address. The output verification component 735 may be configured as or otherwise support a means for verifying that each of the plurality of outputs are a valid output of a cryptographic operation for the public key. The public key verification component 740 may be configured as or otherwise support a means for verifying that the respective plurality of public keys shares form the public key.

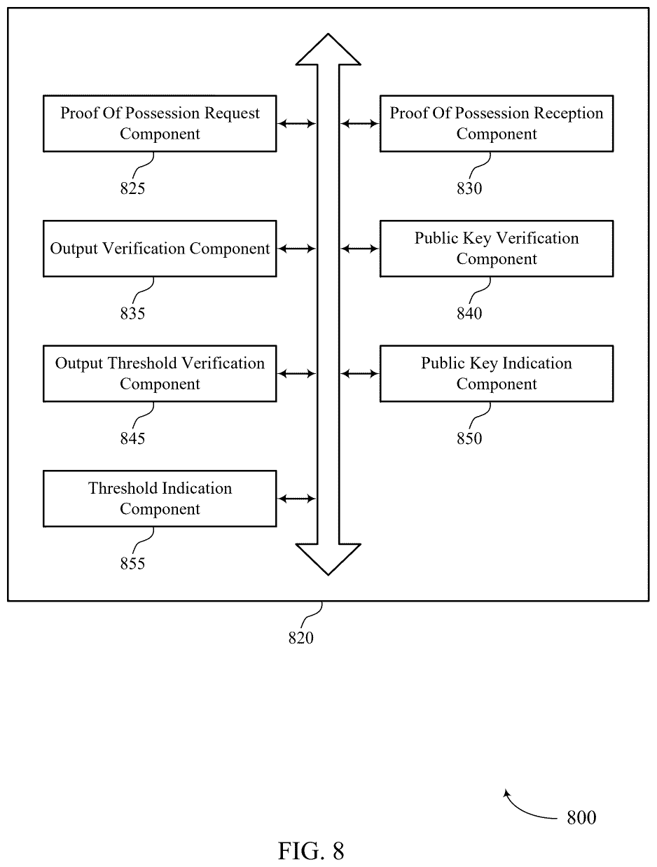

FIG. 8 shows a block diagram 800 of a proof of possession manager 820 that supports distributed proofs of possession for auditing private keys in accordance with aspects of the present disclosure. The proof of possession manager 820 may be an example of aspects of a proof of possession manager or a proof of possession manager 720, or both, as described herein. The proof of possession manager 820, or various components thereof, may be an example of means for performing (e.g., to cause the proof of possession manager 820 to perform) various aspects of distributed proofs of possession for auditing private keys as described herein. For example, the proof of possession manager 820 may include a proof of possession request component 825, a proof of possession reception component 830, an output verification component 835, a public key verification component 840, an output threshold verification component 845, a public key indication component 850, a threshold indication component 855, or any combination thereof. Each of these components, or components of subcomponents thereof (e.g., one or more processors, one or more memories), may communicate, directly or indirectly, with one another (e.g., via one or more buses).

The proof of possession request component 825 may be configured as or otherwise support a means for outputting a first request for a proof of possession of a blockchain address that is associated with a public key, wherein the first request includes an audit message to be used to complete the proof of possession of the blockchain address and using a private key associated with the blockchain address. The proof of possession reception component 830 may be configured as or otherwise support a means for receiving a plurality of outputs and a respective plurality of public key shares of the public key, wherein the plurality of outputs is associated with execution of a cryptographic operation using respective private key shares of a private key associated with the blockchain address, and wherein the plurality of outputs and the respective plurality of public key shares form the proof of possession of the blockchain address and wherein the plurality of outputs are insufficient to construct a verifiable signature for the blockchain address. The output verification component 835 may be configured as or otherwise support a means for verifying that each of the plurality of outputs are a valid output of the cryptographic operation for the public key.

In some examples, the plurality of outputs may include a plurality of signed audit messages that may be signed with the respective private key shares of the private key and, to support verifying that each of the plurality of outputs are a valid output of the cryptographic operation for the public key, the output verification component 835 may be configured as or otherwise support a means for verifying that each of the plurality of signed audit messages are a valid signature for the public key.

In some examples, the public key verification component 840 may be configured as or otherwise support a means for verifying that the respective plurality of public keys shares form the public key.

In some examples, to support verifying that the respective plurality of public key shares form the public key, the public key verification component 840 may be configured as or otherwise support a means for adding together the respective plurality of public key shares to form the public key.

In some examples, the public key indication component 850 may be configured as or otherwise support a means for receiving an indication of the public key, wherein verifying that the respective plurality of public key shares form the public key is performed based at least in part on receiving the indication.

In some examples, the output threshold verification component 845 may be configured as or otherwise support a means for verifying that the plurality of outputs satisfies a threshold quantity of outputs.

In some examples, the threshold indication component 855 may be configured as or otherwise support a means for receiving an indication of the threshold quantity of outputs.

In some examples, to support verifying that each of the plurality of outputs are the valid output of the cryptographic operation for the public key, the output threshold verification component 845 may be configured as or otherwise support a means for verifying that each of the plurality of outputs are the valid signature using an Edwards-curve digital signature algorithm (EdDSA).

In some examples, to support verifying that each of the plurality of outputs are the valid output of the cryptographic operation for the public key, the output verification component 835 may be configured as or otherwise support a means for verifying that each of the plurality of outputs are the valid signature using an elliptic curve digital signature algorithm (ECDSA).

In some examples, the proof of possession request component 825 may be configured as or otherwise support a means for outputting a first request for a proof of possession of a blockchain address that is associated with a public key, wherein the first request includes an audit message to be used to complete the proof of possession of the blockchain address and using a private key associated with the blockchain address. In some examples, the proof of possession reception component 830 may be configured as or otherwise support a means for receiving a plurality of outputs and a respective plurality of public key shares of the public key, wherein the plurality of outputs is associated with execution of a cryptographic operation using respective private key shares of a private key associated with the blockchain address, and wherein the plurality of outputs and the respective plurality of public key shares form the proof of possession of the blockchain address and wherein the plurality of outputs are insufficient to construct a verifiable signature for the blockchain address. In some examples, the output verification component 835 may be configured as or otherwise support a means for verifying that each of the plurality of outputs are a valid output of a cryptographic operation for the public key. The public key verification component 840 may be configured as or otherwise support a means for verifying that the respective plurality of public keys shares form the public key.

In some examples, the plurality of outputs may include a plurality of signed audit messages that are signed with the respective private key shares of the private key, and, to support verifying that each of the plurality of outputs are a valid output of the cryptographic operation for the public key, the output verification component 835 may be configured as or otherwise support a means for verifying that each of the plurality of signed audit messages are a valid signature for the public key.

In some examples, to support verifying that the respective plurality of public key shares form the public key, the public key verification component 840 may be configured as or otherwise support a means for adding together the respective plurality of public key shares to form the public key.

FIG. 9 shows a diagram of a system 900 including a system 905 that supports distributed proofs of possession for auditing private keys in accordance with aspects of the present disclosure. The system 905 may be an example of or include components of a system 705 as described herein. The system 905 may include components for bi-directional voice and data communications including components for transmitting and receiving communications, such as a proof of possession manager 920, an input information 910, an output information 915, a network interface 925, at least one memory 930, at least one processor 935, and a storage 940. Each of these components, or components of subcomponents thereof (e.g., one or more processors, one or more memories), may communicate, directly or indirectly, with one another (e.g., via one or more buses).

The network interface 925 may enable the system 905 to exchange information (e.g., input information 910, output information 915, or both) with other systems or devices (not shown). For example, the network interface 925 may enable the system 905 to connect to a network (e.g., a network 135 as described herein). The network interface 925 may include one or more wireless network interfaces, one or more wired network interfaces, or any combination thereof.

Memory 930 may include RAM, ROM, or both. The memory 930 may store computer-readable, computer-executable software including instructions that, when executed, cause at least one processor 935 to perform various functions described herein, such as functions supporting distributed proofs of possession for auditing private keys. In some cases, the memory 930 may contain, among other things, a basic input/output system (BIOS), which may control basic hardware or software operation such as the interaction with peripheral components or devices. In some cases, the memory 930 may be an example of aspects of one or more components of a custodial token platform 110 as described with reference to FIG. 1. The memory 930 may be an example of a single memory or multiple memories. For example, the system 905 may include one or more memories 930.

The processor 935 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 935 may be configured to execute computer-readable instructions stored in at least one memory 930 to perform various functions (e.g., functions or tasks supporting distributed proofs of possession for auditing private keys). Though a single processor 935 is depicted in the example of FIG. 9, it is to be understood that the system 905 may include any quantity of one or more of processors 935 and that a group of processors 935 may collectively perform one or more functions ascribed herein to a processor, such as the processor 935. The processor 935 may be an example of a single processor or multiple processors. For example, the system 905 may include one or more processors 935.

Storage 940 may be configured to store data that is generated, processed, stored, or otherwise used by the system 905. In some cases, the storage 940 may include one or more HDDs, one or more SDDs, or both. In some examples, the storage 940 may be an example of a single database, a distributed database, multiple distributed databases, a data store, a data lake, or an emergency backup database. In some examples, the storage 940 may be an example of one or more components described with reference to FIG. 1.

For example, the proof of possession manager 920 may be configured as or otherwise support a means for outputting a first request for a proof of possession of a blockchain address that is associated with a public key, wherein the first request includes an audit message to be used to complete the proof of possession of the blockchain address and using a private key associated with the blockchain address. The proof of possession manager 920 may be configured as or otherwise support a means for receiving a plurality of outputs and a respective plurality of public key shares of the public key, wherein the plurality of outputs is associated with execution of a cryptographic operation using respective private key shares of a private key associated with the blockchain address, and wherein the plurality of outputs and the respective plurality of public key shares form the proof of possession of the blockchain address and wherein the plurality of outputs are insufficient to construct a verifiable signature for the blockchain address. The proof of possession manager 920 may be configured as or otherwise support a means for verifying that each of the plurality of outputs are a valid output of the cryptographic operation for the public key.

For example, the proof of possession manager 920 may be configured as or otherwise support a means for outputting a first request for a proof of possession of a blockchain address that is associated with a public key, wherein the first request includes an audit message to be used to complete the proof of possession of the blockchain address and using a private key associated with the blockchain address. The proof of possession manager 920 may be configured as or otherwise support a means for receiving a plurality of outputs and a respective plurality of public key shares of the public key, wherein the plurality of outputs is associated with execution of a cryptographic operation using respective private key shares of a private key associated with the blockchain address, and wherein the plurality of outputs and the respective plurality of public key shares form the proof of possession of the blockchain address and wherein the plurality of outputs are insufficient to construct a verifiable signature for the blockchain address. The proof of possession manager 920 may be configured as or otherwise support a means for verifying that each of the plurality of outputs are a valid output of a cryptographic operation for the public key. The proof of possession manager 920 may be configured as or otherwise support a means for verifying that the respective plurality of public keys shares form the public key.

By including or configuring the proof of possession manager 920 in accordance with examples as described herein, the system 905 may support techniques for increased security, reduced exposure of key shares for a cryptographic key, reduced vulnerability of audit messages, and reduced energy consumption.

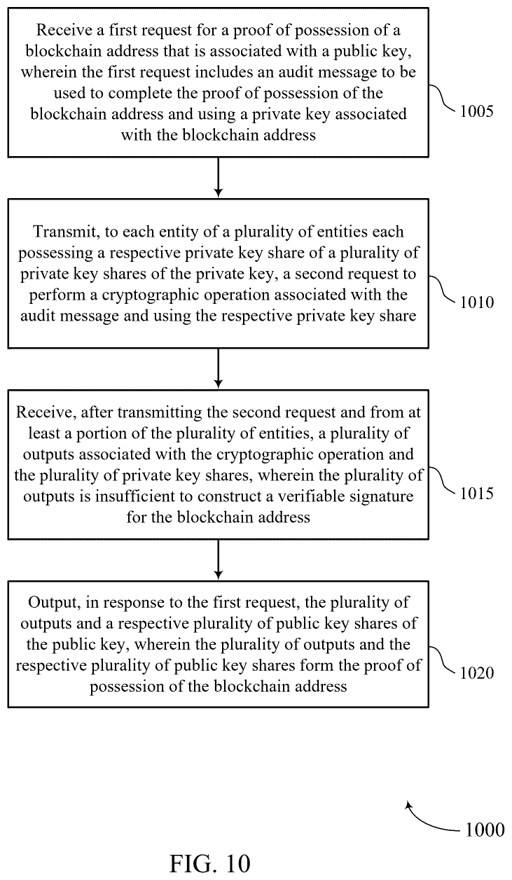

FIG. 10 shows a flowchart illustrating a method 1000 that supports distributed proofs of possession for auditing private keys in accordance with aspects of the present disclosure. The operations of the method 1000 may be implemented by a custodial token platform or its components as described herein. For example, the operations of the method 1000 may be performed by a custodial token platform as described with reference to FIGS. 1 through 6. In some examples, a custodial token platform may execute a set of instructions to control the functional elements of the custodial token platform to perform the described functions. Additionally, or alternatively, the custodial token platform may perform aspects of the described functions using special-purpose hardware.

At 1005, the method may include receiving a first request for a proof of possession of a blockchain address that is associated with a public key, wherein the first request includes an audit message to be used to complete the proof of possession of the blockchain address and using a private key associated with the blockchain address. The operations of 1005 may be performed in accordance with examples as disclosed herein. In some examples, aspects of the operations of 1005 may be performed by a proof of possession request component 525.

At 1010, the method may include transmitting, to each entity of a plurality of entities each possessing a respective private key share of a plurality of private key shares of the private key, a second request to perform a cryptographic operation associated with the audit message and using the respective private key share. The operations of 1010 may be performed in accordance with examples as disclosed herein. In some examples, aspects of the operations of 1010 may be performed by a cryptographic operation request component 530.

At 1015, the method may include receiving, after transmitting the second request and from at least a portion of the plurality of entities, a plurality of outputs associated with the cryptographic operation and the plurality of private key shares, wherein the plurality of outputs is insufficient to construct a verifiable signature for the blockchain address. The operations of 1015 may be performed in accordance with examples as disclosed herein. In some examples, aspects of the operations of 1015 may be performed by a cryptographic operation output component 535.

At 1020, the method may include outputting, in response to the first request, the plurality of outputs and a respective plurality of public key shares of the public key, wherein the plurality of outputs and the respective plurality of public key shares form the proof of possession of the blockchain address. The operations of 1020 may be performed in accordance with examples as disclosed herein. In some examples, aspects of the operations of 1020 may be performed by a proof of possession output component 540.

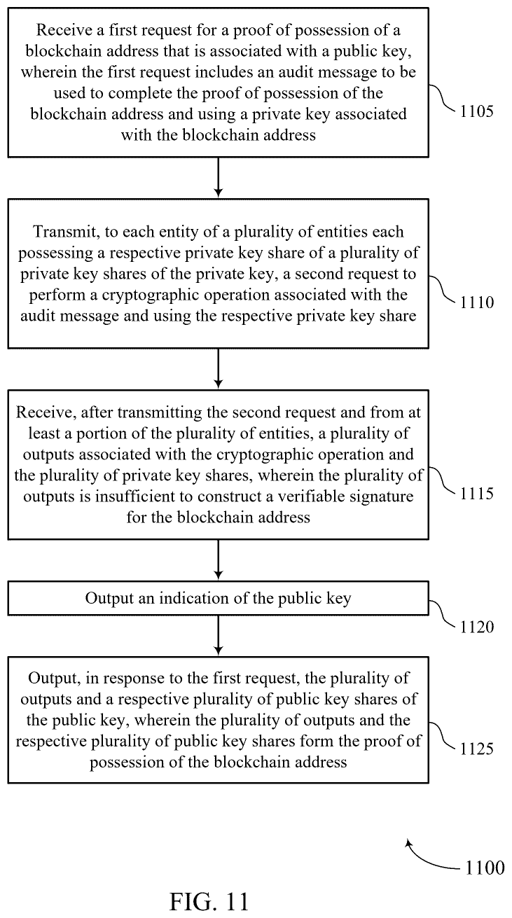

FIG. 11 shows a flowchart illustrating a method 1100 that supports distributed proofs of possession for auditing private keys in accordance with aspects of the present disclosure. The operations of the method 1100 may be implemented by a custodial token platform or its components as described herein. For example, the operations of the method 1100 may be performed by a custodial token platform as described with reference to FIGS. 1 through 6. In some examples, a custodial token platform may execute a set of instructions to control the functional elements of the custodial token platform to perform the described functions. Additionally, or alternatively, the custodial token platform may perform aspects of the described functions using special-purpose hardware.

At 1105, the method may include receiving a first request for a proof of possession of a blockchain address that is associated with a public key, wherein the first request includes an audit message to be used to complete the proof of possession of the blockchain address and using a private key associated with the blockchain address. The operations of 1105 may be performed in accordance with examples as disclosed herein. In some examples, aspects of the operations of 1105 may be performed by a proof of possession request component 525.

At 1110, the method may include transmitting, to each entity of a plurality of entities each possessing a respective private key share of a plurality of private key shares of the private key, a second request to perform a cryptographic operation associated with the audit message and using the respective private key share. The operations of 1110 may be performed in accordance with examples as disclosed herein. In some examples, aspects of the operations of 1110 may be performed by a cryptographic operation request component 530.

At 1115, the method may include receiving, after transmitting the second request and from at least a portion of the plurality of entities, a plurality of outputs associated with the cryptographic operation and the plurality of private key shares, wherein the plurality of outputs is insufficient to construct a verifiable signature for the blockchain address. The operations of 1115 may be performed in accordance with examples as disclosed herein. In some examples, aspects of the operations of 1115 may be performed by a cryptographic operation output component 535.

At 1120, the method may include outputting an indication of the public key. The operations of 1120 may be performed in accordance with examples as disclosed herein. In some examples, aspects of the operations of 1120 may be performed by a public key indication component 545.

At 1125, the method may include outputting, in response to the first request, the plurality of outputs and a respective plurality of public key shares of the public key, wherein the plurality of outputs and the respective plurality of public key shares form the proof of possession of the blockchain address. The operations of 1125 may be performed in accordance with examples as disclosed herein. In some examples, aspects of the operations of 1125 may be performed by a proof of possession output component 540.

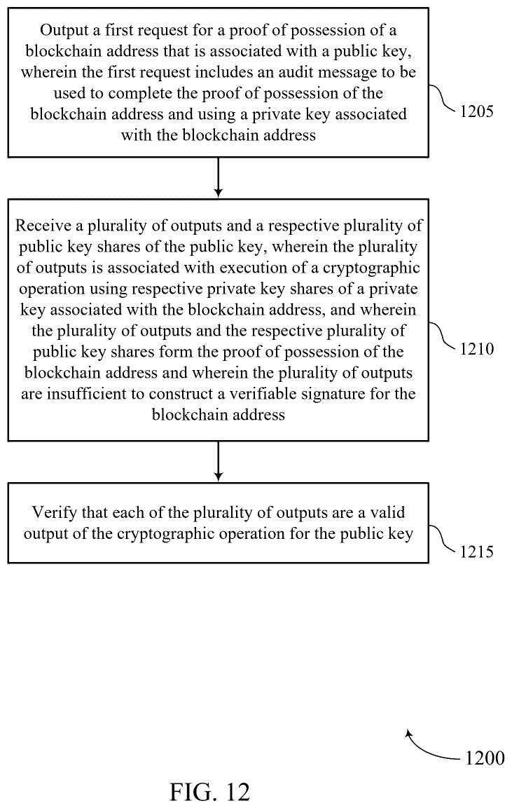

FIG. 12 shows a flowchart illustrating a method 1200 that supports distributed proofs of possession for auditing private keys in accordance with aspects of the present disclosure. The operations of the method 1200 may be implemented by a custodial token platform 2 or its components as described herein. For example, the operations of the method 1200 may be performed by a custodial token platform 2 as described with reference to FIGS. 1 through 3 and 7 through 9. In some examples, a custodial token platform 2 may execute a set of instructions to control the functional elements of the custodial token platform 2 to perform the described functions. Additionally, or alternatively, the custodial token platform 2 may perform aspects of the described functions using special-purpose hardware.

At 1205, the method may include outputting a first request for a proof of possession of a blockchain address that is associated with a public key, wherein the first request includes an audit message to be used to complete the proof of possession of the blockchain address and using a private key associated with the blockchain address. The operations of 1205 may be performed in accordance with examples as disclosed herein. In some examples, aspects of the operations of 1205 may be performed by a proof of possession request component 825.

At 1210, the method may include receiving a plurality of outputs and a respective plurality of public key shares of the public key, wherein the plurality of outputs is associated with execution of a cryptographic operation using respective private key shares of a private key associated with the blockchain address, and wherein the plurality of outputs and the respective plurality of public key shares form the proof of possession of the blockchain address and wherein the plurality of outputs are insufficient to construct a verifiable signature for the blockchain address. The operations of 1210 may be performed in accordance with examples as disclosed herein. In some examples, aspects of the operations of 1210 may be performed by a proof of possession reception component 830.

At 1215, the method may include verifying that each of the plurality of outputs are a valid output of the cryptographic operation for the public key. The operations of 1215 may be performed in accordance with examples as disclosed herein. In some examples, aspects of the operations of 1215 may be performed by an output verification component 835.

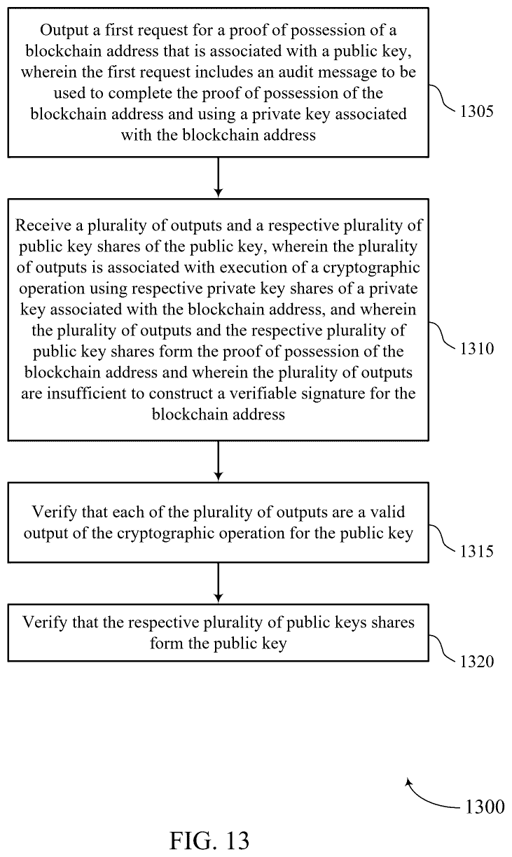

FIG. 13 shows a flowchart illustrating a method 1300 that supports distributed proofs of possession for auditing private keys in accordance with aspects of the present disclosure. The operations of the method 1300 may be implemented by a custodial token platform 2 or its components as described herein. For example, the operations of the method 1300 may be performed by a custodial token platform 2 as described with reference to FIGS. 1 through 3 and 7 through 9. In some examples, a custodial token platform 2 may execute a set of instructions to control the functional elements of the custodial token platform 2 to perform the described functions. Additionally, or alternatively, the custodial token platform 2 may perform aspects of the described functions using special-purpose hardware.

At 1305, the method may include outputting a first request for a proof of possession of a blockchain address that is associated with a public key, wherein the first request includes an audit message to be used to complete the proof of possession of the blockchain address and using a private key associated with the blockchain address. The operations of 1305 may be performed in accordance with examples as disclosed herein. In some examples, aspects of the operations of 1305 may be performed by a proof of possession request component 825.

At 1310, the method may include receiving a plurality of outputs and a respective plurality of public key shares of the public key, wherein the plurality of outputs is associated with execution of a cryptographic operation using respective private key shares of a private key associated with the blockchain address, and wherein the plurality of outputs and the respective plurality of public key shares form the proof of possession of the blockchain address and wherein the plurality of outputs are insufficient to construct a verifiable signature for the blockchain address. The operations of 1310 may be performed in accordance with examples as disclosed herein. In some examples, aspects of the operations of 1310 may be performed by a proof of possession reception component 830.

At 1315, the method may include verifying that each of the plurality of outputs are a valid output of the cryptographic operation for the public key. The operations of 1315 may be performed in accordance with examples as disclosed herein. In some examples, aspects of the operations of 1315 may be performed by an output verification component 835.

At 1320, the method may include verifying that the respective plurality of public keys shares form the public key. The operations of 1320 may be performed in accordance with examples as disclosed herein. In some examples, aspects of the operations of 1320 may be performed by a public key verification component 840.

A method by an apparatus is described. The method may include receiving a first request for a proof of possession of a blockchain address that is associated with a public key, wherein the first request includes an audit message to be used to complete the proof of possession of the blockchain address and using a private key associated with the blockchain address, transmitting, to each entity of a plurality of entities each possessing a respective private key share of a plurality of private key shares of the private key, a second request to perform a cryptographic operation associated with the audit message and using the respective private key share, receiving, after transmitting the second request and from at least a portion of the plurality of entities, a plurality of outputs associated with the cryptographic operation and the plurality of private key shares, wherein the plurality of outputs is insufficient to construct a verifiable signature for the blockchain address, and outputting, in response to the first request, the plurality of outputs and a respective plurality of public key shares of the public key, wherein the plurality of outputs and the respective plurality of public key shares form the proof of possession of the blockchain address.

An apparatus is described. The apparatus may include one or more memories storing processor executable code, and one or more processors coupled with the one or more memories. The one or more processors may individually or collectively be operable to execute the code to cause the apparatus to receive a first request for a proof of possession of a blockchain address that is associated with a public key, wherein the first request includes an audit message to be used to complete the proof of possession of the blockchain address and using a private key associated with the blockchain address, transmit, to each entity of a plurality of entities each possessing a respective private key share of a plurality of private key shares of the private key, a second request to perform a cryptographic operation associated with the audit message and using the respective private key share, receive, after transmitting the second request and from at least a portion of the plurality of entities, a plurality of outputs associated with the cryptographic operation and the plurality of private key shares, wherein the plurality of outputs is insufficient to construct a verifiable signature for the blockchain address, and output, in response to the first request, the plurality of outputs and a respective plurality of public key shares of the public key, wherein the plurality of outputs and the respective plurality of public key shares form the proof of possession of the blockchain address.

Another apparatus is described. The apparatus may include means for receiving a first request for a proof of possession of a blockchain address that is associated with a public key, wherein the first request includes an audit message to be used to complete the proof of possession of the blockchain address and using a private key associated with the blockchain address, means for transmitting, to each entity of a plurality of entities each possessing a respective private key share of a plurality of private key shares of the private key, a second request to perform a cryptographic operation associated with the audit message and using the respective private key share, means for receiving, after transmitting the second request and from at least a portion of the plurality of entities, a plurality of outputs associated with the cryptographic operation and the plurality of private key shares, wherein the plurality of outputs is insufficient to construct a verifiable signature for the blockchain address, and means for outputting, in response to the first request, the plurality of outputs and a respective plurality of public key shares of the public key, wherein the plurality of outputs and the respective plurality of public key shares form the proof of possession of the blockchain address.

A non-transitory computer-readable medium storing code is described. The code may include instructions executable by one or more processors to receive a first request for a proof of possession of a blockchain address that is associated with a public key, wherein the first request includes an audit message to be used to complete the proof of possession of the blockchain address and using a private key associated with the blockchain address, transmit, to each entity of a plurality of entities each possessing a respective private key share of a plurality of private key shares of the private key, a second request to perform a cryptographic operation associated with the audit message and using the respective private key share, receive, after transmitting the second request and from at least a portion of the plurality of entities, a plurality of outputs associated with the cryptographic operation and the plurality of private key shares, wherein the plurality of outputs is insufficient to construct a verifiable signature for the blockchain address, and output, in response to the first request, the plurality of outputs and a respective plurality of public key shares of the public key, wherein the plurality of outputs and the respective plurality of public key shares form the proof of possession of the blockchain address.

In some examples of the method, apparatus, and non-transitory computer-readable medium described herein, the plurality of outputs may include a plurality of signed audit messages and transmitting the second request may include operations, features, means, or instructions for transmitting, to each entity of the plurality of entities each possessing the respective private key share of the private key, the second request to sign the audit message using the respective private key share, wherein the cryptographic operation includes signing the audit message.

In some examples of the method, apparatus, and non-transitory computer-readable medium described herein, public key shares of the respective plurality of public key shares may be additively combinable to form the public key.

In some examples of the method, apparatus, and non-transitory computer-readable medium described herein, the plurality of outputs satisfy a threshold quantity of outputs and a respective signature of the plurality of outputs may be associated with the public key.

Some examples of the method, apparatus, and non-transitory computer-readable medium described herein may further include operations, features, means, or instructions for outputting an indication of the threshold quantity of outputs.

Some examples of the method, apparatus, and non-transitory computer-readable medium described herein may further include operations, features, means, or instructions for outputting an indication of the public key.

In some examples of the method, apparatus, and non-transitory computer-readable medium described herein, the private key may be an Edwards-curve digital signature algorithm (EdDSA) key and the plurality of outputs may be generated using the EdDSA and the respective private key shares.

In some examples of the method, apparatus, and non-transitory computer-readable medium described herein, the private key may be an elliptic curve digital signature algorithm (ECDSA) key and the plurality of outputs may be generated using Schnorr signatures and the respective private key shares.

A method by an apparatus is described. The method may include outputting a first request for a proof of possession of a blockchain address that is associated with a public key, wherein the first request includes an audit message to be used to complete the proof of possession of the blockchain address and using a private key associated with the blockchain address, receiving a plurality of outputs and a respective plurality of public key shares of the public key, wherein the plurality of outputs is associated with execution of a cryptographic operation using respective private key shares of a private key associated with the blockchain address, and wherein the plurality of outputs and the respective plurality of public key shares form the proof of possession of the blockchain address and wherein the plurality of outputs are insufficient to construct a verifiable signature for the blockchain address, and verifying that each of the plurality of outputs are a valid output of the cryptographic operation for the public key.

An apparatus is described. The apparatus may include one or more memories storing processor executable code, and one or more processors coupled with the one or more memories. The one or more processors may individually or collectively be operable to execute the code to cause the apparatus to output a first request for a proof of possession of a blockchain address that is associated with a public key, wherein the first request includes an audit message to be used to complete the proof of possession of the blockchain address and using a private key associated with the blockchain address, receive a plurality of outputs and a respective plurality of public key shares of the public key, wherein the plurality of outputs is associated with execution of a cryptographic operation using respective private key shares of a private key associated with the blockchain address, and wherein the plurality of outputs and the respective plurality of public key shares form the proof of possession of the blockchain address and wherein the plurality of outputs are insufficient to construct a verifiable signature for the blockchain address, and verify that each of the plurality of outputs are a valid output of the cryptographic operation for the public key.

Another apparatus is described. The apparatus may include means for outputting a first request for a proof of possession of a blockchain address that is associated with a public key, wherein the first request includes an audit message to be used to complete the proof of possession of the blockchain address and using a private key associated with the blockchain address, means for receiving a plurality of outputs and a respective plurality of public key shares of the public key, wherein the plurality of outputs is associated with execution of a cryptographic operation using respective private key shares of a private key associated with the blockchain address, and wherein the plurality of outputs and the respective plurality of public key shares form the proof of possession of the blockchain address and wherein the plurality of outputs are insufficient to construct a verifiable signature for the blockchain address, and means for verifying that each of the plurality of outputs are a valid output of the cryptographic operation for the public key.

A non-transitory computer-readable medium storing code is described. The code may include instructions executable by one or more processors to output a first request for a proof of possession of a blockchain address that is associated with a public key, wherein the first request includes an audit message to be used to complete the proof of possession of the blockchain address and using a private key associated with the blockchain address, receive a plurality of outputs and a respective plurality of public key shares of the public key, wherein the plurality of outputs is associated with execution of a cryptographic operation using respective private key shares of a private key associated with the blockchain address, and wherein the plurality of outputs and the respective plurality of public key shares form the proof of possession of the blockchain address and wherein the plurality of outputs are insufficient to construct a verifiable signature for the blockchain address, and verify that each of the plurality of outputs are a valid output of the cryptographic operation for the public key.

In some examples of the method, apparatus, and non-transitory computer-readable medium described herein, the plurality of outputs may include a plurality of signed audit messages that may be signed with the respective private key shares of the private key and verifying that each of the plurality of outputs may be a valid output of the cryptographic operation for the public key may include operations, features, means, or instructions for verifying that each of the plurality of signed audit messages may be a valid signature for the public key.

Some examples of the method, apparatus, and non-transitory computer-readable medium described herein may further include operations, features, means, or instructions for verifying that the respective plurality of public keys shares form the public key.

In some examples of the method, apparatus, and non-transitory computer-readable medium described herein, verifying that the respective plurality of public key shares form the public key may include operations, features, means, or instructions for adding together the respective plurality of public key shares to form the public key.

Some examples of the method, apparatus, and non-transitory computer-readable medium described herein may further include operations, features, means, or instructions for receiving an indication of the public key, wherein verifying that the respective plurality of public key shares form the public key may be performed based at least in part on receiving the indication.

Some examples of the method, apparatus, and non-transitory computer-readable medium described herein may further include operations, features, means, or instructions for verifying that the plurality of outputs satisfies a threshold quantity of outputs.

Some examples of the method, apparatus, and non-transitory computer-readable medium described herein may further include operations, features, means, or instructions for receiving an indication of the threshold quantity of outputs.

In some examples of the method, apparatus, and non-transitory computer-readable medium described herein, verifying that each of the plurality of outputs may be the valid output of the cryptographic operation for the public key may include operations, features, means, or instructions for verifying that each of the plurality of outputs may be the valid signature using an Edwards-curve digital signature algorithm (EdDSA).

In some examples of the method, apparatus, and non-transitory computer-readable medium described herein, verifying that each of the plurality of outputs may be the valid output of the cryptographic operation for the public key may include operations, features, means, or instructions for verifying that each of the plurality of outputs may be the valid signature using an elliptic curve digital signature algorithm (ECDSA).

A method by an apparatus is described. The method may include outputting a first request for a proof of possession of a blockchain address that is associated with a public key, wherein the first request includes an audit message to be used to complete the proof of possession of the blockchain address and using a private key associated with the blockchain address, receiving a plurality of outputs and a respective plurality of public key shares of the public key, wherein the plurality of outputs is associated with execution of a cryptographic operation using respective private key shares of a private key associated with the blockchain address, and wherein the plurality of outputs and the respective plurality of public key shares form the proof of possession of the blockchain address and wherein the plurality of outputs are insufficient to construct a verifiable signature for the blockchain address, verifying that each of the plurality of outputs are a valid output of a cryptographic operation for the public key, and verifying that the respective plurality of public keys shares form the public key.

An apparatus is described. The apparatus may include one or more memories storing processor executable code, and one or more processors coupled with the one or more memories. The one or more processors may individually or collectively be operable to execute the code to cause the apparatus to output a first request for a proof of possession of a blockchain address that is associated with a public key, wherein the first request includes an audit message to be used to complete the proof of possession of the blockchain address and using a private key associated with the blockchain address, receive a plurality of outputs and a respective plurality of public key shares of the public key, wherein the plurality of outputs is associated with execution of a cryptographic operation using respective private key shares of a private key associated with the blockchain address, and wherein the plurality of outputs and the respective plurality of public key shares form the proof of possession of the blockchain address and wherein the plurality of outputs are insufficient to construct a verifiable signature for the blockchain address, verify that each of the plurality of outputs are a valid output of a cryptographic operation for the public key, and verify that the respective plurality of public keys shares form the public key.

Another apparatus is described. The apparatus may include means for outputting a first request for a proof of possession of a blockchain address that is associated with a public key, wherein the first request includes an audit message to be used to complete the proof of possession of the blockchain address and using a private key associated with the blockchain address, means for receiving a plurality of outputs and a respective plurality of public key shares of the public key, wherein the plurality of outputs is associated with execution of a cryptographic operation using respective private key shares of a private key associated with the blockchain address, and wherein the plurality of outputs and the respective plurality of public key shares form the proof of possession of the blockchain address and wherein the plurality of outputs are insufficient to construct a verifiable signature for the blockchain address, means for verifying that each of the plurality of outputs are a valid output of a cryptographic operation for the public key, and means for verifying that the respective plurality of public keys shares form the public key.

A non-transitory computer-readable medium storing code is described. The code may include instructions executable by one or more processors to output a first request for a proof of possession of a blockchain address that is associated with a public key, wherein the first request includes an audit message to be used to complete the proof of possession of the blockchain address and using a private key associated with the blockchain address, receive a plurality of outputs and a respective plurality of public key shares of the public key, wherein the plurality of outputs is associated with execution of a cryptographic operation using respective private key shares of a private key associated with the blockchain address, and wherein the plurality of outputs and the respective plurality of public key shares form the proof of possession of the blockchain address and wherein the plurality of outputs are insufficient to construct a verifiable signature for the blockchain address, verify that each of the plurality of outputs are a valid output of a cryptographic operation for the public key, and verify that the respective plurality of public keys shares form the public key.

In some examples of the method, apparatus, and non-transitory computer-readable medium described herein, the plurality of outputs may include a plurality of signed audit messages that may be signed with the respective private key shares of the private key and verifying that each of the plurality of outputs may be a valid output of the cryptographic operation for the public key may include operations, features, means, or instructions for verifying that each of the plurality of signed audit messages may be a valid signature for the public key.

In some examples of the method, apparatus, and non-transitory computer-readable medium described herein, to verifying that the respective plurality of public key shares form the public key may include operations, features, means, or instructions for adding together the respective plurality of public key shares to form the public key.

It should be noted that the methods described herein describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
receiving a first request for a proof of possession of a blockchain address that is associated with a public key, wherein the first request includes an audit message to be used to complete the proof of possession of the blockchain address and using a private key associated with the blockchain address;
transmitting, to each entity of a plurality of entities each possessing a respective private key share of a plurality of private key shares of the private key, a second request to perform a cryptographic operation associated with the audit message and using the respective private key share;
receiving, after transmitting the second request and from at least a portion of the plurality of entities, a plurality of outputs associated with the cryptographic operation and the plurality of private key shares, wherein the plurality of outputs is insufficient to construct a verifiable signature for the blockchain address; and
outputting, in response to the first request, the plurality of outputs and a respective plurality of public key shares of the public key, wherein the plurality of outputs and the respective plurality of public key shares form the proof of possession of the blockchain address.

2. The method of claim 1, wherein the plurality of outputs comprises a plurality of signed audit messages and wherein transmitting the second request comprises:
transmitting, to each entity of the plurality of entities, the second request to sign the audit message using the respective private key share, wherein the cryptographic operation includes signing the audit message.

3. The method of claim 1, wherein public key shares of the respective plurality of public key shares are additively combinable to form the public key.

4. The method of claim 1, wherein the plurality of outputs satisfy a threshold quantity of outputs, wherein a respective signature of the plurality of outputs is associated with the public key.

5. The method of claim 4, further comprising:
outputting an indication of the threshold quantity of outputs.

6. The method of claim 1, further comprising:
outputting an indication of the public key.

7. The method of claim 1, wherein the private key is an Edwards-curve digital signature algorithm (EdDSA) key and the plurality of outputs are generated using the EdDSA and the respective private key shares.

8. The method of claim 1, wherein the private key is an elliptic curve digital signature algorithm (ECDSA) key and the plurality of outputs are generated using Schnorr signatures and the respective private key shares.

9. A method, comprising:
outputting a first request for a proof of possession of a blockchain address that is associated with a public key, wherein the first request includes an audit message to be used to complete the proof of possession of the blockchain address and using a private key associated with the blockchain address;
receiving a plurality of outputs and a respective plurality of public key shares of the public key, wherein the plurality of outputs is associated with execution of a cryptographic operation using respective private key shares of a private key associated with the blockchain address, and wherein the plurality of outputs and the respective plurality of public key shares form the proof of possession of the blockchain address and wherein the plurality of outputs are insufficient to construct a verifiable signature for the blockchain address; and
verifying that each of the plurality of outputs are a valid output of the cryptographic operation for the public key.

10. The method of claim 9, wherein the plurality of outputs comprises a plurality of signed audit messages that are signed with the respective private key shares of the private key and wherein verifying that each of the plurality of outputs are a valid output of the cryptographic operation for the public key comprises:
verifying that each of the plurality of signed audit messages are a valid signature for the public key.

11. The method of claim 9, further comprising:
verifying that the respective plurality of public keys shares form the public key.

12. The method of claim 11, wherein verifying that the respective plurality of public key shares form the public key comprises:
adding together the respective plurality of public key shares to form the public key.

13. The method of claim 11, further comprising:
receiving an indication of the public key, wherein verifying that the respective plurality of public key shares form the public key is performed based at least in part on receiving the indication.

14. The method of claim 9, further comprising:
verifying that the plurality of outputs satisfies a threshold quantity of outputs.

15. The method of claim 14, further comprising:
receiving an indication of the threshold quantity of outputs.

16. The method of claim 9, wherein verifying that each of the plurality of outputs are the valid output of the cryptographic operation for the public key comprises:
verifying that each of the plurality of outputs are the valid signature using an Edwards-curve digital signature algorithm (EdDSA).

17. The method of claim 9, wherein verifying that each of the plurality of outputs are the valid output of the cryptographic operation for the public key comprises:
verifying that each of the plurality of outputs are the valid signature using an elliptic curve digital signature algorithm (ECDSA).

18. An apparatus, comprising:
one or more memories storing processor-executable code; and
one or more processors coupled with the one or more memories and individually or collectively operable to execute the code to cause the apparatus to:
output a first request for a proof of possession of a blockchain address that is associated with a public key, wherein the first request includes an audit message to be used to complete the proof of possession of the blockchain address and using a private key associated with the blockchain address;
receive a plurality of outputs and a respective plurality of public key shares of the public key, wherein the plurality of outputs is associated with execution of a cryptographic operation using respective private key shares of a private key associated with the blockchain address, and wherein the plurality of outputs and the respective plurality of public key shares form the proof of possession of the blockchain address and wherein the plurality of outputs are insufficient to construct a verifiable signature for the blockchain address;
verify that each of the plurality of outputs are a valid output of a cryptographic operation for the public key; and
verify that the respective plurality of public keys shares form the public key.

19. The apparatus of claim 18, wherein the plurality of outputs comprises a plurality of signed audit messages and wherein, to verify that each of the plurality of outputs are a valid output of the cryptographic operation for the public key, the one or more processors are individually or collectively operable to execute the code to cause the apparatus to:
verify that each of the plurality of signed audit messages are a valid signature for the public key.

20. The apparatus of claim 18, wherein, to verify that the respective plurality of public key shares form the public key, the one or more processors are individually or collectively further operable to execute the code to cause the apparatus to:
add together the respective plurality of public key shares to form the public key.
